(19) United States
(12) Patent Application Publication
(10) Pub. No.: US 2026/0074870 A1
(43) Pub. Date: Mar. 12, 2026

(54) COMMUNICATION CONTROL APPARATUS AND RADIO WAVE PROPAGATION CONTROLLING APPARATUS

(71) Applicant: SONY GROUP CORPORATION, TOKYO (JP)

(72) Inventor: RYOTA KIMURA, TOKYO (JP)

(21) Appl. No.: 19/101,125

(22) PCT Filed: Jun. 29, 2023
(86) PCT No.: PCT/JP2023/024239

§ 371 Date: Feb. 4, 2025

(30) Foreign Application Priority Data
Aug. 12, 2022 (JP) 2022-128950

(51) Int. Cl. H04L 5/00; H04B 17/309; H04W 16/14; H04W 28/18

(52) U.S. Cl. CPC H04L 5/0073; H04B 17/309; H04W 16/14; H04W 28/18

(57) ABSTRACT

[Object] To provide a communication control apparatus that can prevent radio waves of a certain communication apparatus from interfering with radio waves of another communication apparatus or reduce the interference in a wireless communication system in which the radio wave propagation controlling apparatus can be used, where the certain communication apparatus and the other communication apparatus use one wireless communication resource.

[Solving Means] A communication control apparatus includes a first calculator that calculates a distance and a direction between a first communication apparatus and a second communication apparatus on the basis of position information regarding a position of the first communication apparatus and position information regarding a position of the second communication apparatus; a second calculator that calculates characteristics regarding radio wave propagation between the first communication apparatus and the second communication apparatus on the basis of the distance between the first communication apparatus and the second communication apparatus, the direction between the first communication apparatus and the second communication apparatus, position information regarding a position of a radio wave propagation controlling apparatus, and characteristic information regarding characteristics of the radio wave propagation controlling apparatus; and a first determination section that determines an operational parameter for the radio wave propagation controlling apparatus on the basis of the characteristics regarding the radio wave propagation between the first communication apparatus and the second communication apparatus.

### TECHNICAL FIELD

The present disclosure relates to a communication control apparatus and a radio wave propagation controlling apparatus.

### BACKGROUND ART

For example, dynamic spectrum access (DSA) is known as a technology used by a plurality of communication apparatuses to share one wireless communication resource. When conventional DSA is applied, operational parameters for a plurality of communication apparatuses using one frequency resource are set appropriately to prevent or reduce interference of radio waves that is caused between the communication apparatuses of the plurality of communication apparatuses.

Further, due to development of devices of, for example, metamaterial in recent years, a radio wave propagation controlling apparatus that can freely control characteristics regarding radio wave propagation around the radio wave propagation controlling apparatus, that is, specifically, angles of reflection, scatter, diffraction, transmission, and the like of radio waves, is in the process of being put into practical use.

### CITATION LIST

### Patent Literature

Patent Literature 1: Japanese Unexamined Patent Application Publication No. 2019-530387

### DISCLOSURE OF INVENTION

### Technical Problem

It is an object of the present disclosure to provide a communication control apparatus and a radio wave propagation controlling apparatus that can prevent radio waves of a certain communication apparatus from interfering with radio waves of another communication apparatus or reduce the interference in a wireless communication system in which the radio wave propagation controlling apparatus can be used, where the certain communication apparatus and the other communication apparatus use one wireless communication resource.

### Solution to Problem

In order to solve the issues described above, a communication control apparatus according to the present disclosure includes a first receiver that receives position information regarding a position of a first communication apparatus and position information regarding a position of a second communication apparatus; a second receiver that receives position information regarding a position of a radio wave propagation controlling apparatus and characteristic information regarding characteristics of the radio wave propagation controlling apparatus; a first calculator that calculates a distance and a direction between the first communication apparatus and the second communication apparatus on the basis of the position information regarding the position of the first communication apparatus and the position information regarding the position of the second communication apparatus; a second calculator that calculates characteristics regarding radio wave propagation between the first communication apparatus and the second communication apparatus on the basis of the distance between the first communication apparatus and the second communication apparatus, the direction between the first communication apparatus and the second communication apparatus, the position information regarding the position of the radio wave propagation controlling apparatus, and the characteristic information regarding the characteristics of the radio wave propagation controlling apparatus; and a first determination section that determines an operational parameter for the radio wave propagation controlling apparatus on the basis of the characteristics regarding the radio wave propagation between the first communication apparatus and the second communication apparatus.

Further, a radio wave propagation controlling apparatus according to the present disclosure is a radio wave propagation controlling apparatus that is capable of controlling radio-wave-propagation characteristics of the radio wave propagation controlling apparatus according to an operational parameter received from a communication control apparatus.

### BRIEF DESCRIPTION OF DRAWINGS

FIG. 1 illustrates a configuration of a wireless communication system according to a first embodiment.

FIG. 2 illustrates examples in which a primary system and a secondary system use one frequency band.

FIG. 3 illustrates examples in which the primary system and the secondary system use one time period.

FIG. 4 illustrates a detailed configuration of a communication control apparatus according to the first embodiment.

FIG. 5 is a sequence diagram used to describe an operation of a wireless communication network according to the first embodiment.

FIG. 6 is a flowchart used to describe an example of processing of detecting an available radio wave propagation controlling apparatus.

FIG. 7 illustrates two examples of a method for setting a detection range in which an available radio wave propagation controlling apparatus is detected.

FIG. 8 is a flowchart used to describe an example of processing of calculating characteristics regarding radio wave propagation between the first communication apparatus and the second communication apparatus.

FIG. 9 illustrates an overview of geographic information.

FIG. 10 illustrates an example of a method for controlling radio-wave-propagation characteristics of the radio wave propagation controlling apparatus.

FIG. 11 illustrates a data structure of geographic information in detail.

FIG. 12 illustrates a data structure of geographic information, the data structure being meshed with respect to the position.

FIG. 13 is a flowchart used to describe a method for comparing position information to geographic information.

FIG. 14 illustrates a method for specifying a mesh closest to position information.

FIG. 15 illustrates an example of scheduled-use information regarding a wireless communication resource.

FIG. 16 is a flowchart used to describe an example of processing of determining whether a wireless communication resource can be used.

FIG. 17 is a flowchart used to describe an example of processing of determining a maximum allowed transmission power on the basis of a first determination method.

FIG. 18 is a flowchart used to describe an example of processing of determining a maximum allowed transmission power on the basis of a second determination method.

FIG. 19 illustrates an example of a data structure of characteristic information regarding characteristics of a radio access scheme.

FIG. 20 illustrates a data structure of characteristic information regarding characteristics of a radio access scheme, the data structure being meshed with respect to the position.

FIG. 21 is a flowchart used to describe a method for comparing position information to characteristic information regarding characteristics of a radio access scheme.

FIG. 22 is a flowchart used to describe an example of processing of determining a frequency band and a radio access scheme that are used by a communication apparatus.

FIG. 23 illustrates an example of an area in which communication is allowed to be performed, an area in which communication is not allowed to be performed, and a boundary of the areas.

FIG. 24 illustrates an example in which an area in which communication is allowed to be performed and an area in which communication is not allowed to be performed are held as geographic information.

FIG. 25 is a sequence diagram illustrating an example of processing of canceling registration of a communication apparatus or a radio wave propagation controlling apparatus.

FIG. 26 illustrates an example of providing a radio wave propagation controlling apparatus to a building/a structure/a billboard.

FIG. 27 illustrates an example of providing a radio wave propagation controlling apparatus to an audiovisual apparatus.

FIG. 28 illustrates an example of providing a radio wave propagation controlling apparatus to a mobile object/a vehicle.

### MODE(S) FOR CARRYING OUT THE INVENTION

Embodiments of the present disclosure will now be described in detail below with reference to the drawings. In the figures, similar or corresponding structural elements will be denoted by the same reference symbol, and detailed descriptions thereof are omitted as appropriate.

### First Embodiment

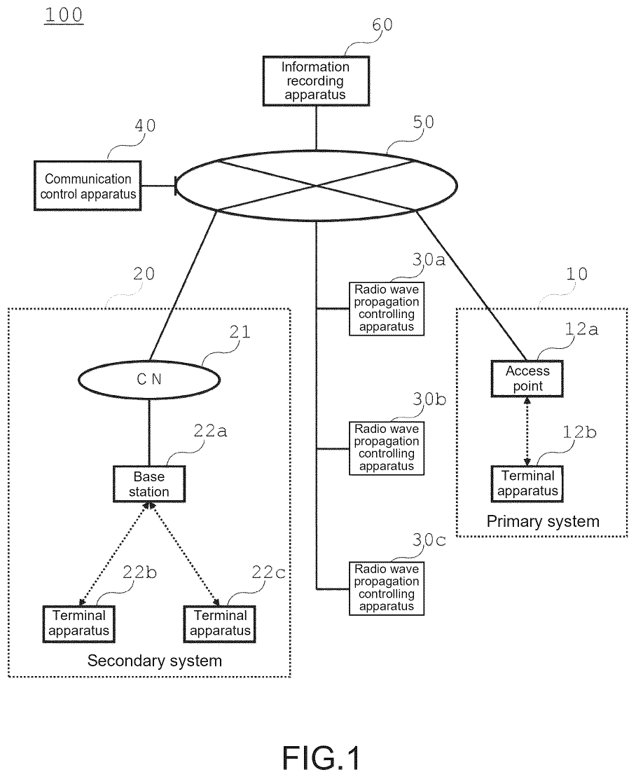

FIG. 1 illustrates a configuration of a wireless communication network 100 according to a first embodiment of the present disclosure. The wireless communication network 100 includes a primary system 10, a secondary system 20, radio wave propagation controlling apparatuses 30a to 30c, and a communication control apparatus 40, and these components are connected through an Internet link 50 to be capable of communicating with each other. Further, the wireless communication network 100 may include an information recording apparatus 60.

In the first embodiment, the primary system 10 is a cellular system such as 3G, 4G, 5G, local 5G, private 5G, Beyond 5G, or 6G. The secondary system 20 is a wireless LAN system such as a WLAN or Wi-Fi. Note that the primary system 10 and the secondary system 20 are not limited to these examples, and each of the primary system 10 and the secondary system 20 may be, for example, an IoT communication system (such as LPWA, Wi-SUN, Zigbee, Sigfox, or LoRa), a TV broadcast system (such as terrestrial broadcasting, satellite broadcasting, or communication of materials used for broadcasting (field pickup unit (FPU))), a defense-and-military communication system, a satellite communication system, or an air-traffic control communication system.

The primary system 10 includes an access point 12a and a terminal apparatus 12b. The access point 12a and the terminal apparatus 12b may be hereinafter respectively referred to as “communication apparatuses 12a and 12b”. The access point 12a is connected to the Internet link 50 by wire or wirelessly. The terminal apparatus 12b is, for example, user equipment (UE), a cellular phone, a smartphone, a smartwatch, smart glasses, or a smart device. The access point 12a and the terminal apparatus 12b can communicate with each other using wireless communication.

The secondary system 20 includes a core network 21, a base station 22a, and terminal apparatuses 22b and 22c. The base station 22a and the terminal apparatuses 22b and 22c may be hereinafter respectively referred to as “communication apparatuses 22a to 22c”. The core network 21 is, for example, an evolved packet core (EPC) or a 5G core (5GC). The core network 21 is connected to the Internet link 50 by wire or wirelessly.

The base station 22a is connected to the core network 21 by wire or wirelessly. Each of the terminal apparatuses 22b and 22c is, for example, UE, a cellular phone, a smartphone, a smartwatch, smart glasses, or a smart device. The base station 22a and each of the terminal apparatuses 22b and 22c can communicate with each other using wireless communication.

Each of the radio wave propagation controlling apparatuses 30a to 30c is an apparatus that can freely control characteristics regarding radio wave propagation through a space around a corresponding one of the radio wave propagation controlling apparatuses 30a to 30c, that is, specifically, angles of reflection, scatter, diffraction, transmission, and the like of radio waves. The radio-wave-propagation characteristics of each of the radio wave propagation controlling apparatuses 30a to 30c can be controlled by setting an operational parameter. The radio wave propagation controlling apparatus is also called, for example, a reconfigurable intelligent surface (RIS), a metasurface, an intelligent surface, a large intelligent surface, a radio wave shutter, or a reflective plate. The radio wave propagation controlling apparatuses 30a to 30c are each connected to the Internet link 50 by wire or wirelessly.

The communication control apparatus 40 determines operational parameters for the communication apparatuses 22a to 22c included in the secondary system 20 and operational parameters for the radio wave propagation controlling apparatuses 30a to 30c, so as to prevent radio waves of the secondary system 20 from interfering with radio waves of the primary system 10 or reduce the interference when the primary system 10 and the secondary system 20 use one wireless communication resource. The communication control apparatus 40 is connected to the Internet link 50 by wire or wirelessly.

The communication control apparatus 40 can communicate with each of the communication apparatuses 12a and 12b included in the primary system 10 through the Internet link 50. The communication control apparatus 40 can communicate with each of the communication apparatuses 22a to 22c included in the secondary system 20 through the Internet link 50 and the core network 21. The communication control apparatus 40 can communicate with each of the radio wave propagation controlling apparatuses 30a to 30c through the Internet link 50. Further, when there is the information recording apparatus 60, the communication control apparatus 40 can communicate with the information recording apparatus 60 through the Internet link 50.

The information recording apparatus 60 records and keeps therein information regarding the communication apparatuses 12a and 12b included in the primary system 10, information regarding the communication apparatuses 22a to 22c included in the secondary system 20, information regarding the radio wave propagation controlling apparatuses 30a to 30c, and information regarding the communication control apparatus 40. Examples of the information recording apparatus 60 include the Productive and Reliable Telecommunications Network for Radio Stations (PARTNER) in Japan, a system operation adjusting system, in Japan, that uses, for example, a TV white space, the FCC Universal Licensing System (ULS) in the United States, the Equipment Authorization System (EAS) in the United States, and Informing Incumbent Portal used in the CBRS in the United States. The information recording apparatus 60 is connected to the Internet link 50 by wire or wirelessly.

Note that it is sufficient if the wireless communication network 100 illustrated in FIG. 1 includes at least one primary system 10 and at least one secondary system 20, and the wireless communication network 100 may include two or more primary systems 10 and two or more secondary systems 20. It is also sufficient if the primary system 10 and the secondary system 20 each include at least one communication apparatus. It is also sufficient if there are at least one radio wave propagation controlling apparatus 30 and at least one communication control apparatus 40. Further, when there is the information recording apparatus 60, the number of information recording apparatuses 60 may be one, or two or more.

### (Relationship Between Frequency Bands Used by Primary System and Secondary System)

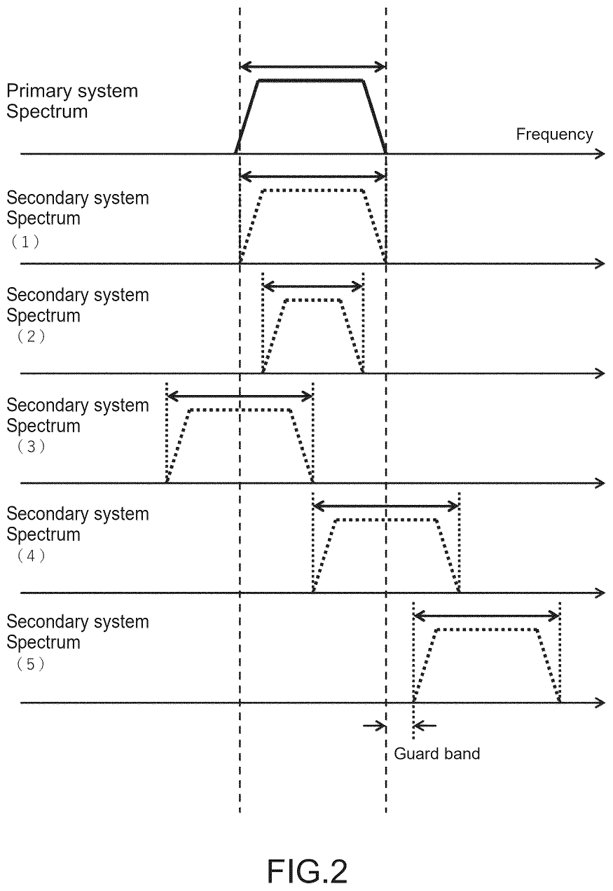

In the first embodiment, the primary system 10 and the secondary system 20 use one frequency band, one frequency channel, or one spectrum. FIG. 2 illustrates five examples in which the primary system 10 and the secondary system 20 use one frequency band. All of the examples are examples in which “one frequency band is used”, and radio waves of the secondary system 20 may interfere with radio waves of the primary system 10.

(1) and (2) of FIG. 2 each illustrate an example in which the entirety of a frequency band used by the secondary system 20 is included in a frequency band used by the primary system 10. (3) and (4) of FIG. 2 each illustrate an example in which a portion of the frequency band used by the secondary system 20 overlaps the frequency band used by the primary system 10. (5) of FIG. 2 illustrates an example in which the frequency band used by the secondary system 20 and the frequency band used by the primary system 10 do not overlap but a space between the respective frequency bands, that is, for example, a guard band has a width less than or equal to a specified width. In this case, out-of-band emission of a radio wave emitted by the secondary system 20 may interfere with the primary system 10.

To summarize the description above, the use of one frequency band by the primary system 10 and the secondary system 20 can be represented as indicated below.

$${F}_{P , Lower} \leq {F}_{S , Lower} and {F}_{S , Upper} \leq {F}_{P , Upper} ( ( 1 ) and ( 2 ) of Fig . 2 )$$

$${F}_{S , Lower} \leq {F}_{P , Lower} and {F}_{P , Lower} \leq {F}_{S , Upper} ( ( 3 ) and of Fig . 2 )$$

$${F}_{S , Lower} \leq {F}_{P , Upper} and {F}_{P , Upper} \leq {F}_{S , Upper} ( ( 4 ) and of Fig . 2 )$$

$$0 \leq {F}_{P , Lower} - {F}_{S , Upper} \leq {B}_{P , S , Guard} or 0 \leq {F}_{S , Lower} - {F}_{P , Upper} \leq {B}_{P , S , Guard} ( ( 5 ) of Fig . 2 )$$

Note that, in the formulars described above, F_{P,Lower} and F_{P,Upper} respectively represent a lower limit and an upper limit of the frequency band used by the primary system 10 (F_{P,Lower}≤F_{P,Upper}), F_{S,Lower} and F_{S,Upper} respectively represent a lower limit and an upper limit of the frequency band used by the secondary system 20 (F_{S,Lower}≤F_{S,Upper}), and B_{P,S,Guard} represents a specified width of a guard band provided when one frequency band is considered to be used (0≤B_{P,S,Guard}).

### (Relationship Between Time Periods Used by Primary System and Secondary System)

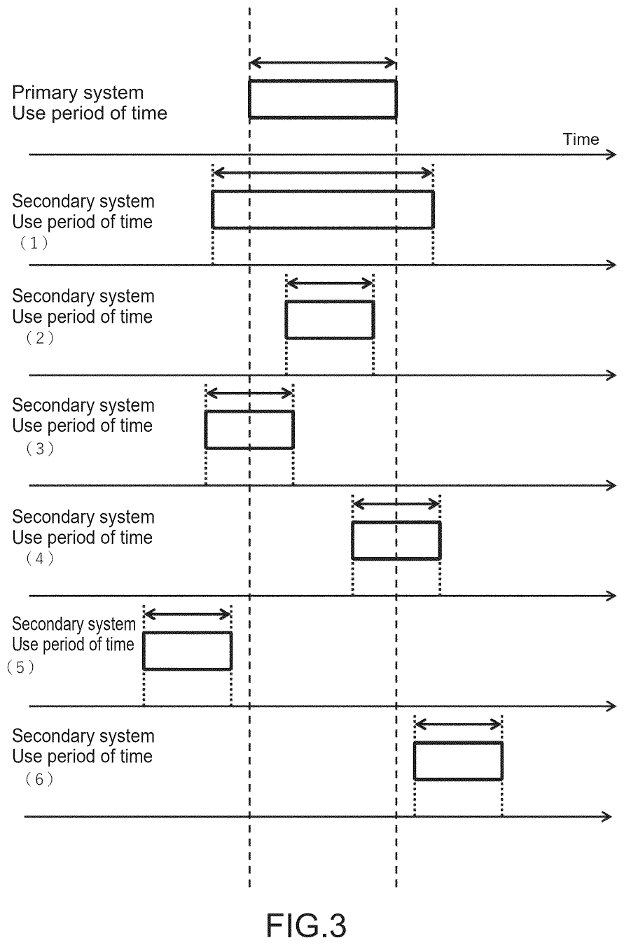

A time period or a time slot can be considered, as in the case of the frequency band. FIG. 3 illustrates five examples in which the primary system 10 and the secondary system 20 use one time period. All of the examples are examples in which “one time period is used”, and radio waves of the secondary system 20 may interfere with radio waves of the primary system 10.

(1) of FIG. 3 illustrates an example in which a time period used by the secondary system 20 includes the entirety of a time period used by the primary system 10. (2) of FIG. 3 illustrates an example in which the entirety of the time period used by the secondary system 20 is included in the time period used by the primary system 10. (3) and (4) of FIG. 3 each illustrate an example in which a portion of the time period used by the secondary system 20 overlaps the time period used by the primary system 10. (5) and (6) of FIG. 3 each illustrate an example in which the time period used by the secondary system 20 and the time period used by the primary system 10 do not overlap but an interval between the respective time period, that is, for example, a guard time is less than or equal to a specified length. In this case, a rising time and a falling time of a radio wave emitted by the secondary system 20 may interfere with the primary system 10.

To summarize the description above, the use of one time period by the primary system 10 and the secondary system 20 can be represented as indicated below.

$${T}_{P , Start} \leq {F}_{S , Start} and {T}_{S , End} \leq {T}_{P , End} ( ( 1 ) and ( 2 ) of Fig . 2 )$$

$${T}_{S , Start} \leq {T}_{P , Start} and {T}_{P , Start} \leq {T}_{S , End} ( ( 3 ) and of Fig . 2 )$$

$${T}_{S , Start} \leq {T}_{P , End} and {T}_{P , End} \leq {T}_{S , End} ( ( 4 ) and of Fig . 2 )$$

$$0 \leq {T}_{P , Start} - {T}_{S , End} \leq {T}_{P , S , Guard} or 0 \leq {T}_{S , Start} - {T}_{P , End} \leq {T}_{P , S , Guard} ( ( 5 ) and ( 6 ) of Fig . 2 )$$

Note that, in the formulars described above, T_{P,Start} and T_{P,End} respectively represent a start point and an end point of the time period used by the primary system 10 (T_{P,Start}≤T_{P,End}), T_{S,Start} and T_{S,End} respectively represent a start point and an end point of the time period used by the secondary system 20 (T_{S,Start}≤T_{S,End}), and T_{P,S,Guard} represents a specified length of a guard time provided when one time period is considered to be used (0≤T_{P,Scommunication,Guard}).

### (Communication Control Protocol for Wireless Communication Network)

In the first embodiment, the communication apparatuses 12a and 12b included in the primary system 10 and the communication apparatuses 22a to 22c included in the secondary system 20 use one frequency band. Thus, if no measures are taken, radio waves of the secondary system 20 may interfere with radio waves of the primary system 10. The communication control apparatus 40 determines operational parameters for the communication apparatuses 22a to 22c included in the secondary system 20 and operational parameters for the radio wave propagation controlling apparatuses 30a to 30c so as to prevent radio waves of the secondary system 20 from interfering with radio waves of the primary system 10 or reduce the interference.

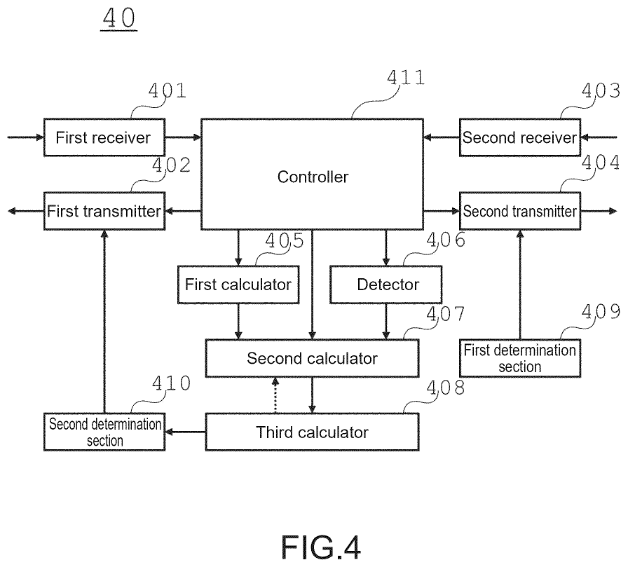

FIG. 4 illustrates a detailed configuration of the communication control apparatus 40 according to the first embodiment. The communication control apparatus 40 includes a first receiver 401, a first transmitter 402, a second receiver 403, a second transmitter 404, a first calculator 405, a detector 406, a second calculator 407, a third calculator 408, a first determination section 409, a second determination section 410, and a controller 411.

The first receiver 401 receives a registration request including position information from each of the communication apparatuses 12a and 12b and the communication apparatuses 22a to 22c. The first transmitter 402 transmits back a registration completion report to each of the communication apparatuses 12a and 12b and the communication apparatuses 22a to 22c. Further, the first transmitter 402 transmits an operational parameter to at least one of the communication apparatuses 22a to 22c included in the secondary system 20.

The second receiver 403 receives a registration request including position information and characteristic information from each of the radio wave propagation controlling apparatuses 30a to 30c. The second transmitter 404 transmits back a registration completion report to each of the radio wave propagation controlling apparatuses 30a to 30c. Further, the second transmitter 404 transmits an operational parameter to an available radio wave propagation controlling apparatus.

The first calculator 405 calculates a distance and a direction between a first communication apparatus included in the secondary system 20 and a second communication apparatus included in the primary system 10. The detector 406 detects a radio wave propagation controlling apparatus available to prevent radio waves of the first communication apparatus from interfering with radio waves of the second communication apparatus or to reduce the interference. The second calculator 407 calculates characteristics regarding radio wave propagation between the first communication apparatus and the second communication apparatus. The third calculator 408 calculates power of an interference signal received by the second communication apparatus when the first communication apparatus emits radio waves.

The first determination section 409 determines an operational parameter for an available radio wave propagation controlling apparatus. The second determination section 410 determines an operational parameter for at least one of the communication apparatuses 22a to 22c included in the secondary system 20. The controller 411 controls an overall operation of the communication control apparatus 40.

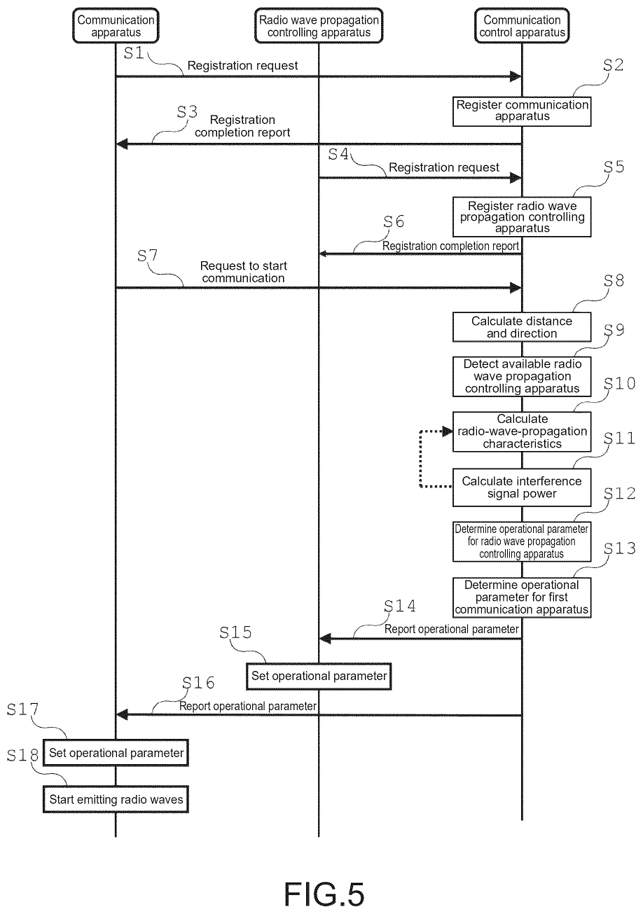

FIG. 5 is a sequence diagram used to describe an operation of the wireless communication network 100 according to the first embodiment. In FIG. 5, “communication apparatuses” refer to the communication apparatuses 12a and 12b and the communication apparatuses 22a to 22c. “Radio wave propagation controlling apparatuses” refer to the radio wave propagation controlling apparatuses 30a to 30c. A “communication control apparatus” refers to the communication control apparatus 40. Further, FIG. 5 illustrates a link between each of the communication apparatus and the radio wave propagation controlling apparatus, and the communication control apparatus regardless of whether each of the communication apparatus and the radio wave propagation controlling apparatus, and the communication control apparatus are connected to each other directly or indirectly.

In Step S1 of FIG. 5, the communication apparatuses 12a and 12b included in the primary system 10 and 22a to 22c included in the secondary system 20 each transmit, to the communication control apparatus 40, a registration request including position information regarding a position of a corresponding one of the communication apparatuses 12a and 12b and 22a to 22c (such as latitude, longitude, altitude, 2D coordinates, and 3D coordinates). The first receiver 401 of the communication control apparatus 40 receives the registration request transmitted by the communication apparatuses 12a and 12b and 22a to 22c. The controller 411 of the communication control apparatus 40 registers, with an internal memory of the controller 411, the position information included in the received registration request (Step S2). The first transmitter 402 of the communication control apparatus 40 transmits back a registration completion report to each of the communication apparatuses 12a and 12b and 22a to 22c (Step S3). This registration enables 22a to 22c included in the secondary system 20 to receive, from the communication control apparatus 40, an operational parameter described later, and thus to receive benefits brought by spectrum sharing.

In Step S4 of FIG. 5, the radio wave propagation controlling apparatuses 30a to 30c each transmit, to the communication control apparatus 40, a registration request including position information regarding a position of a corresponding one of the radio wave propagation controlling apparatuses 30a to 30c and characteristic information regarding characteristics of the corresponding one of the radio wave propagation controlling apparatuses 30a to 30c. The second receiver 403 of the communication control apparatus 40 receives the registration request transmitted by each of the radio wave propagation controlling apparatuses 30a to 30c. The controller 411 of the communication control apparatus 40 registers, with the internal memory of the controller 411, the position information and characteristic information included in the received registration request (Step S5). The second transmitter 404 of the communication control apparatus 40 transmits back a registration completion report to each of the radio wave propagation controlling apparatuses 30a to 30c (Step S6). This registration enables each of the radio wave propagation controlling apparatuses 30a to 30c to receive, from the communication control apparatus 40, an operational parameter described later, and thus to perform operation that makes it possible to improve effects provided by spectrum sharing.

The following are specific examples of the position information regarding each of the radio wave propagation controlling apparatuses 30a to 30c and of the characteristic information regarding characteristics of a corresponding one of the radio wave propagation controlling apparatuses 30a to 30c.

### Position Information

Installation position (latitude, longitude, altitude, 2D coordinates, and 3D coordinates)
Opening surface (size, horizontal/vertical)
   Characteristic information
Supported frequency band
Supported radio access system
Acceptable range of angle (horizontal/vertical)
Acceptable amount of radio attenuation/acceptable amount of amplification (horizontal/vertical)
Acceptable granularity of control (time, frequency, and space)
Accuracy in synchronizing with secondary system (time)

In Step S7 of FIG. 5, a certain communication apparatus that is, for example, the communication apparatus 22b included in the secondary system 20 transmits, to the communication control apparatus 40, a request to start communication of the communication apparatus 22b. The communication control apparatus 40 receiving the request determines an operational parameter for the communication apparatus 22b and determines an operational parameter for an available radio wave propagation controlling apparatus from among the radio wave propagation controlling apparatuses 31a to 30c if any, such that radio waves emitted by the communication apparatus 22b included in the secondary system 20 do not interfere with communication performed by the communication apparatuses 12a and 12b being included in the primary system 10 and using the same frequency band as the communication apparatus 22b.

Specifically, the communication control apparatus 40 performs the processes of and after Step S8 of FIG. 5. Further, the communication apparatus 22b included in the secondary system 20 is hereinafter referred to as the “first communication apparatus”, and the communication apparatuses 12a and 12b included in the primary system 10 are hereinafter referred to as the “second communication apparatuses”. Note that, here, only the communication apparatus 22b included in the secondary system 20 is referred to as the first communication apparatus, but a plurality of communication apparatuses included in the secondary system 20 may be collectively referred to as the first communication apparatus. Further, the communication apparatuses 12a and 12b included in the primary system 10 are collectively referred to as the second communication apparatus, but only one of the communication apparatuses 12a and 12b may be referred to as the second communication apparatus.

In Step S8 of FIG. 5, the first calculator 405 of the communication control apparatus 40 calculates a distance and a direction between the first communication apparatus and the second communication apparatus on the basis of position information regarding a position of the first communication apparatus and position information regarding a position of the second communication apparatus that are registered in Step S2 described above. Here, the position information regarding a position of the first communication apparatus is position information regarding a position of the communication apparatus 22b. Further, the position information regarding a position of the second communication apparatus is, for example, position information regarding a position of a point intermediate between the communication apparatuses 12a and 12b.

First, an example in which the position information is given by coordinates of X, Y, and Z is described, where an X axis is provided in an east-west direction, a Y axis is provided in a north-south direction, and a Z axis is provided in a height direction, without considering that the Earth is a sphere. Here, a two-dimensional distance between the first communication apparatus and the second communication apparatus can be calculated using a formula indicated below, where a position Loc₁ of the first communication apparatus is represented by [X₁,Y₁,Z₁], and a position Loc₂ of the second communication apparatus is represented by [X₂,Y₂,Z₂].

$${D}_{h , 1 \to 2} = \sqrt{{( {X}_{1} - {X}_{2} )}^{2} + {( {Y}_{1} - {Y}_{2} )}^{2}} \qquad [ Math . 1 ]$$

Further, a three-dimensional distance between the first communication apparatus and the second communication apparatus can be calculated using a formula indicated below.

$${D}_{ν , 1 \to 2} = \sqrt{{D}_{h 1 \to 2}^{2} + {( {Z}_{1} - {Z}_{2} )}^{2}} \qquad [ Math . 2 ]$$

An azimuth angle at the position Loc₂ in the horizontal direction as viewed from the position Loc₁ can be calculated using a formula indicated below, where the north direction is zero radian.

$${θ}_{1 \to 2} = arccos ( \frac{\vert {Y}_{2} - {Y}_{1} \vert}{{D}_{h , 1 \to 2}} ) \qquad [ Math . 3 ]$$

An azimuth angle at the position Loc, in the horizontal direction as viewed from the position Loc₂ can be calculated using a formula indicated below, where the north direction is zero radian.

$${θ}_{2 \to 1} = {θ}_{1 \to 2} + π \qquad [ Math . 4 ]$$

An angle at the position Loc₂ in the vertical direction as viewed from the position Loc₁ can be calculated using a formula indicated below, where the zenith direction is zero radian.

$${ϕ}_{1 \to 2} = arccos ( \frac{\vert {Z}_{2} - {Z}_{1} \vert}{{D}_{v , 1 \to 2}} ) \qquad [ Math . 5 ]$$

An angle at the position Loc₁ in the vertical direction as viewed from the position Loc₂ can be calculated using a formula indicated below, where the zenith direction is zero radian.

$${ϕ}_{2 \to 1} = π - {ϕ}_{1 \to 2} \qquad [ Math . 6 ]$$

Next, an example in which the position information is given by coordinates of latitude A and longitude B is described, with considering that the Earth is a sphere. Here, a two-dimensional distance between the first communication apparatus and the second communication apparatus can be calculated using a formula indicated below, where the position Loc₁ of the first communication apparatus is represented by [A₁,B₁], the position Loc₂ of the second communication apparatus is represented by [A₂,B₂], and an equatorial Earth radius is represented by R.

$$D = Rarccos [ sin ( {B}_{1} ) sin ( {B}_{2} ) + cos ( {B}_{1} ) cos ( {B}_{2} ) cos ( {A}_{2} - {A}_{1} ) ] \qquad [ Math . 7 ]$$

Further, an azimuth angle at the position Loc₂ as viewed from the position Loc₁ can be calculated using a formula indicated below, where the north direction is 0 degrees, the east direction is 90 degrees, the south direction is 180 degrees, and the west direction is 270 degrees.

$${ϕ}_{1 \to 2} = 90 - atan 2 [ sin ( {A}_{2} - {A}_{1} ) , cos ( {B}_{1} ) tan ( {B}_{2} ) - sin ( {B}_{1} ) cos ( {A}_{2} - {A}_{1} ) ] \qquad [ Math . 8 ]$$

Note that a correspondence relationship between each of the directions of north, south, east, and west, and an angle is not limited thereto. Further, the function a tan 2(x,y) refers to arctan taking two arguments. Furthermore, in addition to using the calculation method described above, the distance and the direction may be calculated using a geodetic method such as the inverse solution or forward solution of the Vincenty's formulate.

In Step S9 of FIG. 5, the detector 406 of the communication control apparatus 40 detects a radio wave propagation controlling apparatus (the number of radio wave propagation controlling apparatuses can be two or more) available to prevent radio waves of the first communication apparatus from interfering with radio waves of the second communication apparatus or reduce the interference, on the basis of the position information regarding a position of each of the radio wave propagation controlling apparatuses 30a to 30c and the characteristic information regarding characteristics of a corresponding one of the radio wave propagation controlling apparatuses 30a to 30c, the position information and characteristic information being registered in Step S5 described above. In other words, in the first embodiment, not all of the radio wave propagation controlling apparatuses are used at all times, but only a radio wave propagation controlling apparatus suitable in terms of position and frequency is used, so as to prevent radio waves of the first communication apparatus included in the secondary system 20 from interfering with radio waves of the second communication apparatus included in the primary system 10.

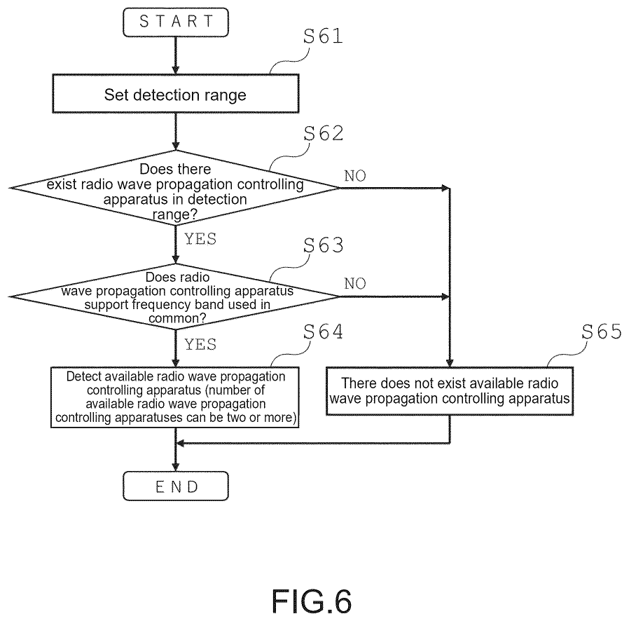

FIG. 6 is a flowchart used to describe an example of processing of detecting, in the first embodiment, a radio wave propagation controlling apparatus (the number of radio wave propagation controlling apparatuses can be two or more) available to prevent the first communication apparatus included in the secondary system 20 from interfering with the second communication apparatus included in the primary system 10 or reduce the interference.

The detector 406 of the communication control apparatus 40 sets a range in which an available radio wave propagation controlling apparatus (the number of radio wave propagation controlling apparatuses can be two or more) is detected (Step S61), and determines whether at least one registered radio wave propagation controlling apparatus exists in the detection range (Step S62).

When at least one registered radio wave propagation controlling apparatus exists in the detection range (Step S62=YES), the detector 406 of the communication control apparatus 40 determines whether there is a radio wave propagation controlling apparatus, from among the at least one registered radio wave propagation controlling apparatus, that supports a frequency band shared to be used by the first communication apparatus and the second communication apparatus (Step S63).

When there is a radio wave propagation controlling apparatus that supports the frequency band shared to be used by the first communication apparatus and the second communication apparatus (Step S63=YES), the detector 406 of the communication control apparatus 40 detects the radio wave propagation controlling apparatus as a radio wave propagation controlling apparatus (the number of radio wave propagation controlling apparatuses can be two or more) available to prevent radio waves of the first communication apparatus from interfering with radio waves of the second communication apparatus or reduce the interference (Step S64).

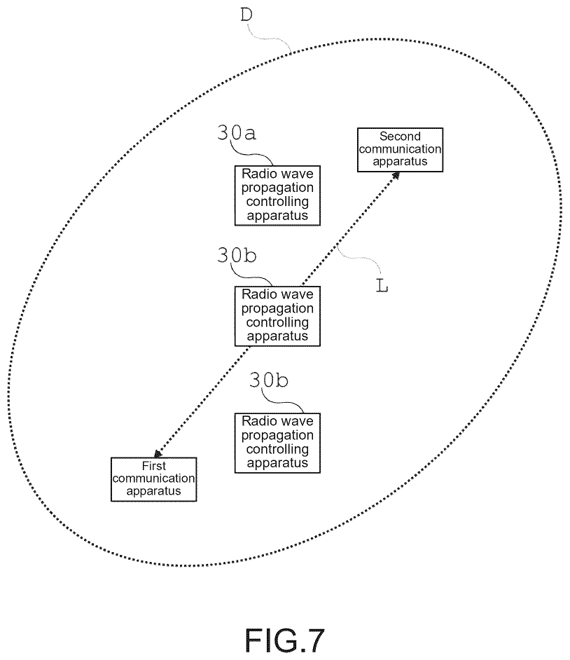

FIG. 7 illustrates two examples of a method for setting a detection range in which the available radio wave propagation controlling apparatus (the number of radio wave propagation controlling apparatuses can be two or more) is detected, the setting being performed in Step S61 of FIG. 6. In a first example, a line L that connects the first communication apparatus and the second communication apparatus is set to be a detection range, and the radio wave propagation controlling apparatus 30b situated in the line L is detected as an available radio wave propagation controlling apparatus. Note that, in FIG. 7, a straight line connects the two communication apparatuses, but a curved line or a zigzag line may connect the two communication apparatuses.

In a second example, a two- or three-dimensional region D in which the first communication apparatus and the second communication apparatus are situated is set to be a detection range, and the radio wave propagation controlling apparatuses 30a to 30c situated in the range D are detected as available radio wave propagation controlling apparatuses. Actually, radio wave propagation exhibits angular spread. Thus, there is a radio wave that travels in a direction other than a direction of a straight line. Thus, there are advantages in setting a two- or three-dimensional region as a detection range in which an available radio wave propagation controlling apparatus is detected.

In Step S10 of FIG. 5, the second calculator 407 of the communication control apparatus 40 calculates characteristics regarding radio wave propagation between the first communication apparatus and the second communication apparatus. In particular, in a versatile radio-wave-propagation model, attenuation L_{1→2} of signal power that is caused due to radio waves propagating from the first communication apparatus to the second communication apparatus can be represented in a decibel (dB) representation, as indicated below.

$${L}_{1 \to 2} = - {G}_{1} ( {θ}_{1 \to 2} , {ϕ}_{1 \to 2} ) + {L}_{p} ( {D}_{h , 1 \to 2} , {D}_{v , 1 \to {2}_{}} , {Loc}_{1} , {Loc}_{2} , {F}_{C} , Map ) - {G}_{2} ( {θ}_{2 \to 1} , {ϕ}_{2 \to 1} ) \qquad [ Math . 9 ]$$

In the formula above, G₁ represents an antenna gain of the first communication apparatus at the position Loc₁, and G₂ represents an antenna gain of the second communication apparatus at the position Loc₂. In general, the antenna gain can be a function of a horizontal angle θ and a vertical angle φ.

Further, Lp represents characteristics regarding radio wave propagation between two communication apparatuses (with no interruption). Fc represents a carrier frequency that is assumed in the radio-wave-propagation model. Map represents, for example, geographic information, landform information, or map information that is referred to in the radio-wave-propagation model. Such information is hereinafter referred to as “geographic information” considered to be representative of such information.

Note that, generally, it is often assumed that L_{1→2}=L_{2→1}. Further, the gain G and the attenuation L exhibit positive values in principle. The gain G exhibiting a positive value means that signal power is made stronger. The attenuation L exhibiting a positive value means that signal power is made weaker. Note that the gain G and the attenuation L can also exhibit negative values in terms of expression. The gain G exhibiting a negative value means that signal power is made weaker. The attenuation L exhibiting a negative value means that signal power is made stronger.

Further, radio-wave-propagation characteristics Lp (with no interruption) divided into smaller elements can be represented, for example, as indicated below.

$${L}_{p} = {L}_{D} ( {D}_{h , 1 \to 2} , {D}_{v , 1 \to 2} , {Loc}_{1} , {Loc}_{2} , {F}_{C} , Map ) + {L}_{S} ( {Loc}_{1} , {F}_{C} , Map ) + {L}_{S} ( {Loc}_{2} , {F}_{C} , Map ) + {L}_{F} ( {Loc}_{1} , {F}_{C} , Map , t ) + {L}_{F} ( {Loc}_{2} , {F}_{C} , Map , t ) \qquad [ Math . 10 ]$$

In the formula above, L_{D} represents a term dependent on a distance between the two communication apparatuses (what is called distance attenuation). L_{S} represents attenuation due to, for example, a shielding object around a certain position Loc (what is called shadowing). L_{F} represents, for example, attenuation dependent on reflection, scatter, diffraction, transmission, or the like that occurs at the certain position Loc; or dependent on time taken for, for example, movement (what is called fading).

There are various radio-wave-propagation models, and the various radio-wave-propagation models can be classified roughly as indicated below. Further, those models are not completely independent of each other, and there may be a model having combined features.

### Deterministic Model:

It is often the case that this model primarily corresponds to L_{D} in the formula above.
Example a: free space model
Example b: exponential decay model

### Stochastic or Probabilistic Model:

It is often the case that this model primarily corresponds to L_{S} or L_{F} in the formula above.
Example a: shadowing (shadowing, log-normal fading)
Example b: fading (small-scale fading, fast fading)·

### Geographic Model (Geographic Model, Location-Specific Model):

It is often the case that, for example, geographic information, landform information, or map information is adopted more finely.
Note that this does not mean that the other models described above do not use, for example, geographic information.
   Example a: Hata model
   Example b: irregular terrain model (ITM)
   Example c: ITU-R P.1546
   Example d: ITU-R P.452

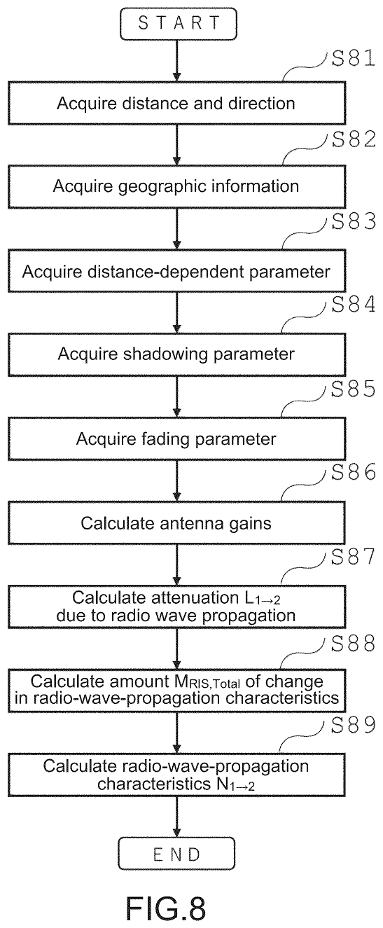

FIG. 8 is a flowchart used to describe an example of processing of calculating, in the first embodiment, characteristics regarding radio wave propagation between the first communication apparatus and the second communication apparatus.

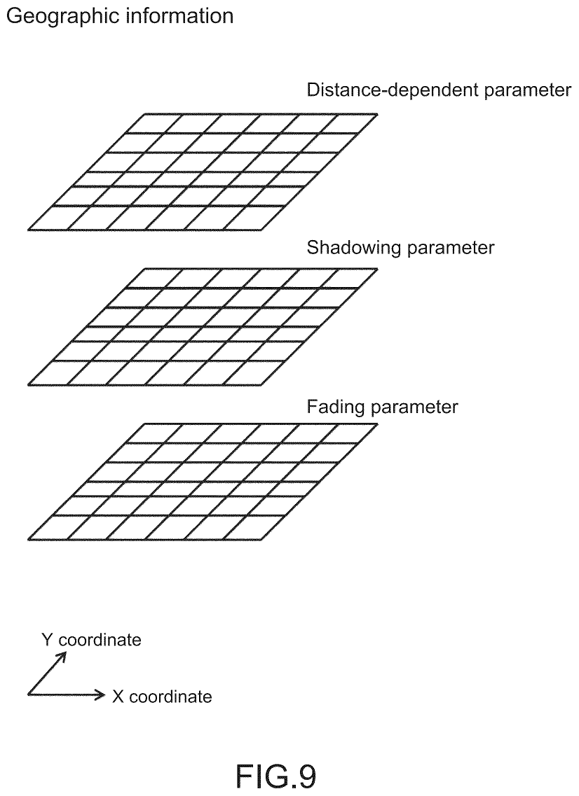

In Step S81, the second calculator 407 of the communication control apparatus 40 acquires a distance and a direction between the first communication apparatus and the second communication apparatus, the distance and direction being calculated in Step S8 of FIG. 5. In Step S82, the second calculator 407 of the communication control apparatus 40 acquires geographic information regarding geography exhibited between the first communication apparatus and the second communication apparatus. FIG. 9 illustrates an overview of geographic information. Values of various parameters that have an impact on radio-wave-propagation characteristics are recorded at each position on a map partitioned in a grid.

In Step S83, the second calculator 407 of the communication control apparatus 40 compares pieces of position information regarding positions of the first communication apparatus and the second communication apparatus to the geographic information acquired in Step S82 described above to acquire a value of a distance-dependent parameter that has an impact on characteristics regarding radio wave propagation between the first communication apparatus and the second communication apparatus. Specific examples of the distance-dependent parameter include an exponential coefficient in the exponential decay model (such as square law, cubic law, fourth-power law, and α-th-power law (α is a real number)), and an environmental setting in the Hata model (such as an open land, the suburbs, a small or medium-sized city, and a large city).

In Step S84, the second calculator 47 of the communication control apparatus 40 compares the pieces of position information regarding positions of the first communication apparatus and the second communication apparatus to the geographic information acquired in Step S82 described above to acquire a value of a shadowing parameter that has an impact on characteristics regarding radio wave propagation between the first communication apparatus and the second communication apparatus. Specific examples of the shadowing parameter include a variance value in a lognormal distribution (such as σ_S decibels (σ_S is a real number)).

In Step S85, the communication control apparatus 40 compares the pieces of position information regarding positions of the first communication apparatus and the second communication apparatus to the geographic information acquired in Step S82 described above to acquire a value of a fading parameter that has an impact on characteristics regarding radio wave propagation between the first communication apparatus and the second communication apparatus. Specific examples of the fading parameter include a delay wave number upon multipath propagation, a level of power of each delay wave, a delay time of the delay wave, Rayleigh fading, Rician fading, and a K-factor.

In Step S86, the second calculator 407 of the communication control apparatus 40 calculates the respective antenna gains G₁ and G₂ of the first communication apparatus and the second communication apparatus on the basis of an azimuth angle between (the horizontal direction, the vertical direction) the first communication apparatus and the second communication apparatus, the azimuth angle being acquired in Step S81.

In Step S87, the second calculator 407 of the communication control apparatus 40 calculates attenuation L_{1→2} of signal power that is caused due to radio waves propagating from the first communication apparatus to the second communication apparatus, according to the above-described definition formula for attenuation L_{1→2}, using values of the various parameters acquired or calculated in Steps S81 to S86 described above.

In Step S88, the second calculator 407 of the communication control apparatus 40 calculates an amount M_{RIS,Total,1→2} of a change in characteristics regarding radio wave propagation from the first communication apparatus to the second communication apparatus, the change being caused by the available radio wave propagation controlling apparatus (the number of radio wave propagation controlling apparatuses can be two or more) detected in Step S9 of FIG. 5.

In particular, the amount M_{RIS,Total,1→2} of a change in characteristics regarding radio wave propagation is changed due to the number of radio wave propagation controlling apparatuses, or radio-wave-propagation characteristics of the radio wave propagation controlling apparatus, that is, specifically, an angle of reflection, scatter, diffraction, transmission, or the like of the radio waves. Further, radio-wave-propagation characteristics of the radio wave propagation controlling apparatus can be controlled by setting an operational parameter for the radio wave propagation controlling apparatus. In the first embodiment, it is assumed that M_{RIS,Total,1→2} represents a scalar quantity and may exhibit a positive or negative value. Note that the first embodiment is expected to provide an effect of making power of an interference signal weaker using a radio wave propagation controlling apparatus. Thus, radio-wave-propagation characteristics of the radio wave propagation controlling apparatus are favorably controlled such that M_{RIS,Total,1→2} exhibits a positive value.

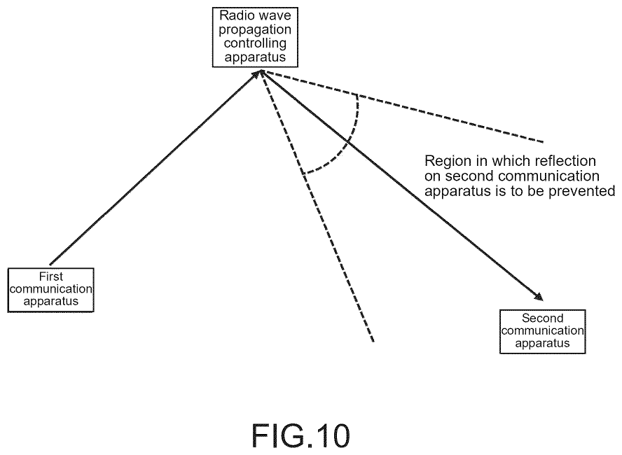

FIG. 10 illustrates an example of a method for controlling radio-wave-propagation characteristics of the radio wave propagation controlling apparatus, where interference with radio waves of the second communication apparatus that is performed due to radio waves of the first communication apparatus is intended to be reduced. The communication control apparatus 40 controls radio-wave-propagation characteristics of the radio wave propagation controlling apparatus, that is, specifically, angles of reflection, scatter, diffraction, transmission, and the like of the radio waves emitted by the first communication apparatus, such that the radio waves are not reflected to be headed for the second communication apparatus. A direction in which reflection is prevented may be defined in the form of a straight line that connects the radio wave propagation controlling apparatus and the second communication apparatus, or may be defined in the form of a region with angular spread. Here, at least one of horizontal angular spread or vertical angular spread is favorably considered when angular spread is considered. Further, the same way of thinking can be applied to each one of a plurality of radio wave propagation controlling apparatuses when radio-wave-propagation characteristics of the plurality of radio wave propagation controlling apparatuses are controlled.

The second calculator 407 of the communication control apparatus 40 calculates an amount M_{RIS,1→2} of a change in radio-wave-propagation characteristics that is caused by each available radio wave propagation controlling apparatus (the number of radio wave propagation controlling apparatuses can be two or more), and calculates M_{RIS,Total,1→2} by integrating the respective change amounts M_{RIS,1→2}. The values of M_{RIS,1→2} are integrated by addition for values in decibels or by multiplication for true values.

In Step S89, the second calculator 407 of the communication control apparatus 40 calculates characteristics N_{1→2} regarding radio wave propagation between the first communication apparatus and the second communication apparatus using a formula indicated below, on the basis of the attenuation L_{1→2} of signal power that is caused due to radio waves propagating from the first communication apparatus to the second communication apparatus and calculated in Step S87 described above, and on the basis of the amount M_{RIS,Total,1→2} of a change in radio-wave-propagation characteristics that is calculated in Step S88 described above, the change being caused by the radio wave propagation controlling apparatus.

$${N}_{1 \to 2} = {L}_{1 \to 2} + {M}_{RIS , Total , 1 \to 2} \qquad [ Math . 11 ]$$

In Step S11 of FIG. 5, the third calculator 408 of the communication control apparatus 40 calculates, using a formula indicated below, power I_{1→2} of an interference signal received by the second communication apparatus when the first communication apparatus emits radio waves.

$${I}_{1 \to 2} = {P}_{T , 1} - {N}_{1 \to 2} \qquad [ Math . 12 ]$$

In the formula described above, P_{T,1} represents transmission power of radio waves emitted by the first communication apparatus. N_{1→2} represents the characteristics regarding radio wave propagation between the first communication apparatus and the second communication apparatus that are calculated in Step S10 described above. Note that, when a total of interference signals from a plurality of communication apparatuses, that is, for example, aggregate interference from the plurality of communication apparatuses is considered, an aggregate interference power I_{Agg,2} received by the second communication apparatus can be calculated using a formula indicated below.

$${I}_{Agg , 2} = 10 {log}_{10} ( {\sum }_{n} {10}^{\frac{{I}_{n \to 2}}{10}} ) \qquad [ Math . 13 ]$$

In the first embodiment, transmission power P_{T,1} of the first communication apparatus is determined such that power of an interference signal received by the second communication apparatus exhibits a value smaller than or equal to a specified value, that is, specifically, a value of a practically negligible level, and the amount M_{RIS,Total,1→2} of a change in radio-wave-propagation characteristics that is obtained in Step S88 described above is controlled, the change being caused by the radio wave propagation controlling apparatus. The description above is represented by a dotted arrow extending from the third calculator 408 to the second calculator 407 in FIG. 4, and a dotted arrow extending from Step S11 to Step S10 in FIG. 5.

In Step S12 of FIG. 5, the first determination section 409 of the communication control apparatus 40 determines an operational parameter for the available radio wave propagation controlling apparatus (the number of radio wave propagation controlling apparatuses can be two or more) detected in Step S9 described above. In particular, the first determination section 409 of the communication control apparatus 40 determines an operational parameter for the radio wave propagation controlling apparatus such that the term of M_{RIS,Total,1→2} in the radio-wave-propagation characteristics L_{1→2}30 M_{RIS,Total,1→2} is obtained, the radio-wave-propagation characteristics L_{1→2}+M_{RIS,Total,1→2} being calculated in Step S10 described above.

In Step S13 of FIG. 5, the second determination section 410 of the communication control apparatus 40 determines an operational parameter for the first communication apparatus. Specific examples of the operational parameter include whether a wireless communication resource can be used, a maximum allowed transmission power, a frequency band to be used, a radio access scheme to be used, an area in which communication is allowed to be performed, an area in which communication is not allowed to be performed, a boundary, and a minimum separation distance. In particular, a maximum allowed transmission power of the first transmission apparatus is determined to be equal to the transmission power P_{T,1} in Step S10 described above.

In Step S14 of FIG. 5, the second transmitter 404 of the communication control apparatus 40 transmits the operational parameter determined in Step S12 described above to the radio wave propagation controlling apparatus. The radio wave propagation controlling apparatus receiving the operational parameter sets, for the radio wave propagation controlling apparatus itself, the operational parameter (Step S15).

In Step S16 of FIG. 5, the first transmitter 402 of the communication control apparatus 40 transmits the operational parameter determined in Step S13 described above to the first communication apparatus. The first communication apparatus receiving the operational parameter sets, for the first communication apparatus itself, the operational parameter (Step S17), and starts emitting radio waves (Step S18). Here, according to the radio-wave-propagation characteristics N_{1→2} calculated in Step S10 described above, the radio waves emitted by the first communication apparatus are attenuated before the radio waves arrive at the second communication apparatus. This results in preventing the radio waves of the first communication apparatus from interfering with radio waves of the second communication apparatus, or in reducing the interference.

As described above, the communication control apparatus 40 according to the first embodiment includes the first calculator 405, the second calculator 407, and the first determination section 409, where the first calculator 405 calculates a distance and a direction between the first communication apparatus and the second communication apparatus on the basis of position information regarding a position of the first communication apparatus and position information regarding a position of the second communication apparatus; the second calculator 407 calculates characteristics N_{1→2} regarding radio wave propagation between the first communication apparatus and the second communication apparatus on the basis of the distance between the first communication apparatus and the second communication apparatus, the direction between the first communication apparatus and the second communication apparatus, position information regarding a position of a radio wave propagation controlling apparatus, and characteristic information regarding characteristics of the radio wave propagation controlling apparatus; and the first determination section 409 determines an operational parameter for the radio wave propagation controlling apparatus on the basis of the characteristics N_{1→2} regarding radio wave propagation between the first communication apparatus and the second communication apparatus.

In the first embodiment, the features described above result in preventing radio waves of the secondary system 20 including the first communication apparatus from interfering with radio waves of the primary system 10 including the second communication apparatus or in reducing the interference.

Conventionally, when one wireless communication resource is shared to be used by a plurality of communication apparatuses, only operational parameters for (for example, maximum allowed transmission powers of) the communication apparatuses are controlled to prevent or reduce interference of radio waves. Thus, characteristics regarding radio wave propagation between communication apparatuses are not controlled. In other words, for existing technologies, the characteristics regarding radio wave propagation between communication apparatuses communication apparatus are merely preconditions, and are not to be controlled.

On the other hand, in the case of the communication control apparatus 40 according to the first embodiment, not only an operational parameter for a communication apparatus but also an operational parameter for a radio wave propagation controlling apparatus is controlled. This makes it possible to positively control characteristics regarding radio wave propagation between communication apparatuses, and thus to more effectively prevent or reduce interference of radio waves.

Further, the communication control apparatus 40 according to the first embodiment further includes the detector 406 detecting a radio wave propagation controlling apparatus that is available to prevent radio waves of the first communication apparatus from interfering with radio waves of the second communication apparatus or to reduce the interference. The second calculator 407 only considers position information regarding a position of the available radio wave propagation controlling apparatus and characteristic information regarding characteristics of the available radio wave propagation controlling apparatus when the second calculator 407 calculates characteristics N_{1→2} regarding radio wave propagation between the first communication apparatus and the second communication apparatus.

According to the features described above, only a radio wave propagation controlling apparatus expected to provide effects is controlled in the first embodiment. This results in very efficiently preventing radio waves of the secondary system 20 including the first communication apparatus from interfering with radio waves of the primary system 10 including the second communication apparatus or in very efficiently reducing the interference.

Further, when the second calculator 407 of the communication control apparatus 40 according to the first embodiment calculates characteristics N_{1→2} regarding radio wave propagation between the first communication apparatus and the second communication apparatus, the second calculator 407 considers geographic information regarding geography exhibited between the first communication apparatus and the second communication apparatus, that is, specifically, a distance-dependent parameter, a shadowing parameter, a fading parameter, and the like that have an impact on the radio-wave-propagation characteristics N_{1→2}.

According to the features described above, radio-wave-propagation characteristics N_{1→2} are calculated accurately in the first embodiment. This results in very effectively preventing radio waves of the secondary system 20 including the first communication apparatus from interfering with radio waves of the primary system 10 including the second communication apparatus or in very effectively reducing the interference.

### (Details of Data Structure of Geographic Information)

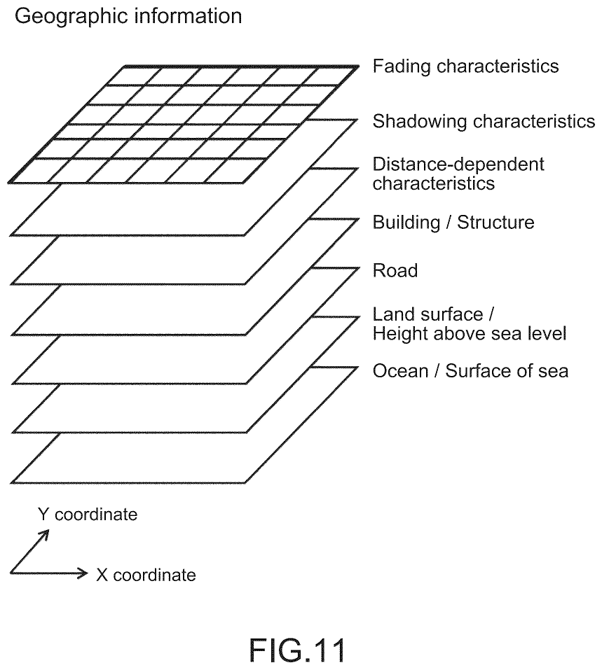

FIG. 11 illustrates a data structure of geographic information according to the present disclosure in detail. In order to calculate radio-wave-propagation characteristics on the basis of a radio-wave-propagation model, it is necessary to consider a plurality of attributes and a plurality of factors with respect to geography, a landform, and a map, as illustrated in the figure. For example, attributes and factors, such as the ocean, a surface of the sea, a land surface, and height above the sea level, that are relatively close to a natural environment or a native environment are conceivable. Examples of the attributes and factors such as the ocean, a surface of the sea, a land surface, and height above the sea level may include not only height information but also the quality of water, the nature of soil, and the quality of a material, as well as a radio-wave-reflection coefficient and a radio-wave-transmission coefficient that are associated with the quality of water, the nature of soil, or the quality of a material. Further, attributes and factors, such as a road, a building, and a structure, that are close to artificial objects are also conceivable. Examples of the attributes and factors such as a road, a building, and a structure may include a size and the quality of a material, as well as a radio-wave-reflection coefficient and a radio-wave-transmission coefficient that are associated with the quality of a material. The geographic information may directly include the attributes and factors having an impact on the radio-wave-propagation characteristics. Examples of the attributes and factors having an impact on the radio-wave-propagation characteristics may include distance-dependent characteristics, shadowing characteristics, and fading characteristics.

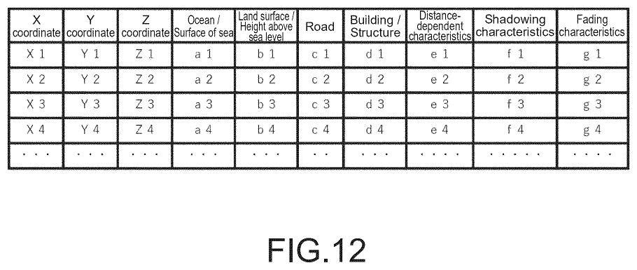

The data structure of geographic information may be meshed with respect to the position, as illustrated in FIG. 12. Moreover, the geographic information illustrated in FIG. 12 may further generate for each frequency band. The radio-wave-propagation characteristics are dependent on frequency. Thus, more accurate calculation can be performed by applying a plurality of pieces of geographic information according to such a feature. When there are pieces of geographic information for a plurality of frequency bands, position-and-coordinate information may be shared. The following is an advantage provided by sharing the position-and-coordinate information: when position information is compared to geographic information, the number of times of comparison can be reduced using the position-and-coordinate information as a key. When, for example, there are pieces of geographic information for M frequency bands, the number of times of comparison will be only 1/M in the case in which the position-and-coordinate information is shared, compared to when the position-and-coordinate information is not shared.

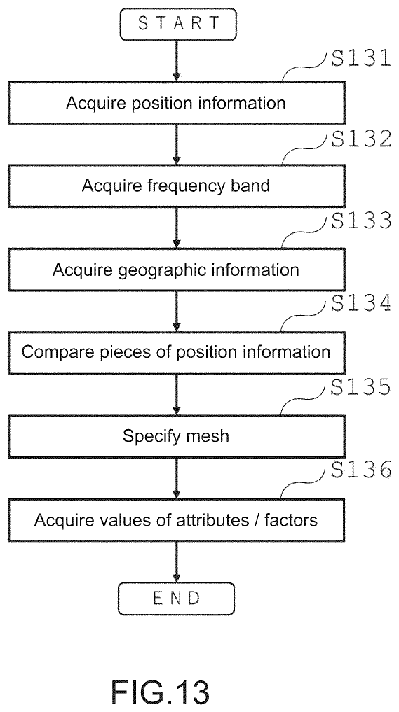

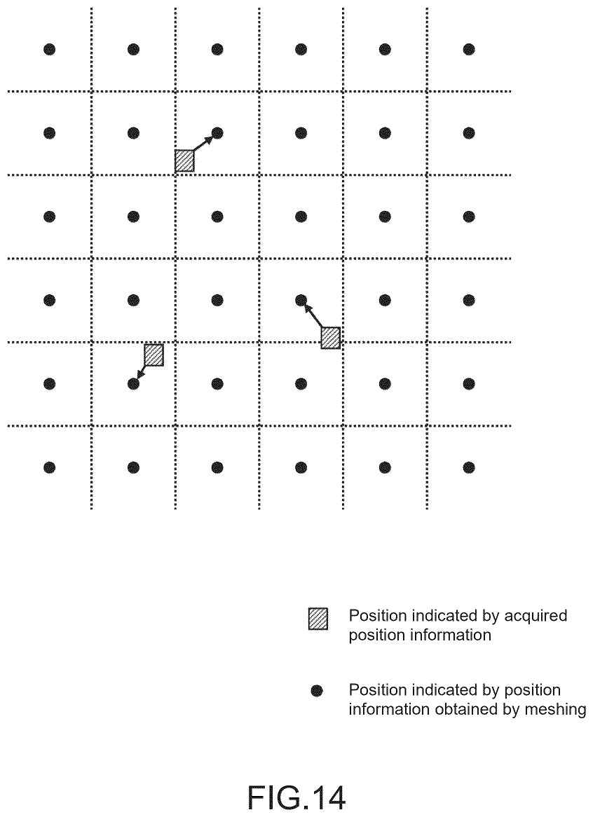

FIG. 13 is a flowchart used to describe a method for comparing position information to geographic information. First, position information that is to be checked against geographic information is acquired (Step S131). Next, when a specific frequency band is desired or designated (Step S132), geographic information corresponding to the frequency band is acquired (Step S133). Next, position information/coordinate information that is included in the geographic information and obtained by meshing is compared with check-target position information (Step S134), and a mesh that is closest to the check-target position information is specified (Step S135). In the comparison and specifying, a method is adopted that includes comparing distances between position information obtained by meshing and check-target position information and specifying a closest mesh, as illustrated in FIG. 14. Finally, values of attributes and factors of geographic information, that is, values in a specific line in FIG. 12, are acquired, the values of the attributes and factors being set for and associated with the specified mesh (Step S136).

### (Operational Parameter (Whether Wireless Communication Resource can be Used))

In the present disclosure, the communication control apparatus 40 reports an operational parameter to a communication system or a communication apparatus. Examples of information included in an operational parameter include whether a wireless communication resource can be used by the communication system or the communication apparatus. In particular, when a target communication system or a target communication apparatus belongs to the secondary system or intends to use a frequency band used by another communication system, the communication control apparatus 40 reports to the target communication system or the target communication apparatus about whether a wireless communication resource can be used.

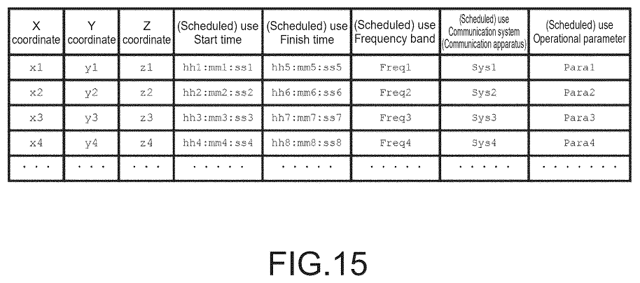

FIG. 15 illustrates an example of scheduled-use information regarding a wireless communication resource, the scheduled-use information being held by the communication control apparatus 40. In the figure, for example, a communication system Sys1 is scheduled to use the wireless communication resource at a position x1/y1/z1 for a period of time from a time hh1:mm:ss1 to a time hh5:mm5:ss5 in a frequency band Freq1, and an operational parameter Paral is set for the communication system Sys1 and a communication apparatus that belongs to the communication system Sys1.

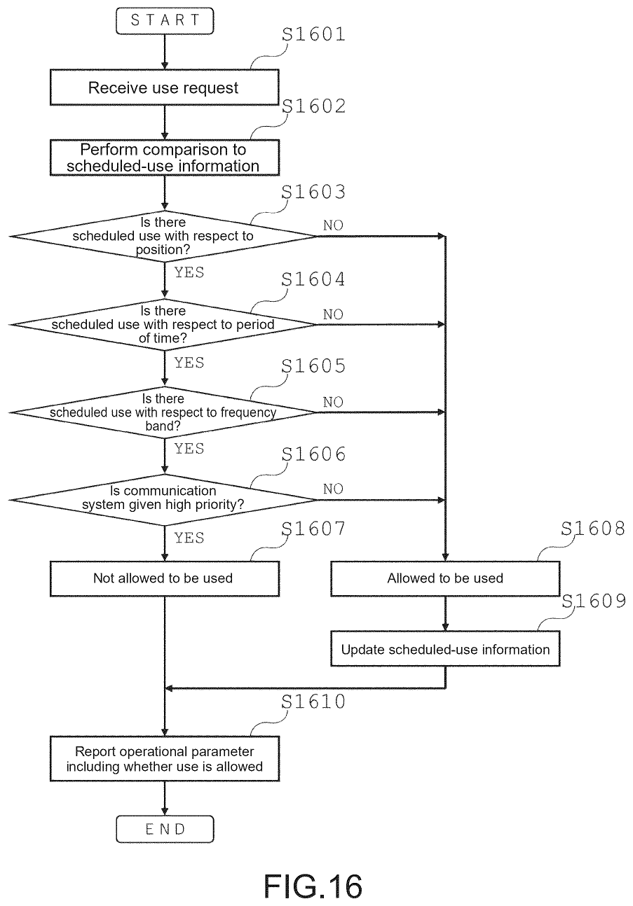

FIG. 16 is a flowchart used to describe an example of processing of determining whether a wireless communication resource can be used.

First, the communication control apparatus 40 receives, from a certain communication system or a certain communication apparatus, a request to use a wireless communication resource at a specific position for a specific period of time in a specific frequency band (Step S1601). In the above-described sequence illustrated in FIG. 5, the use request may be included in information that the communication apparatus reports to the communication control apparatus 40 or in a registration request transmitted from the communication apparatus to the communication control apparatus 40, and the information or registration request including the use request may be reported.

The communication control apparatus 40 compares the received request to use a wireless communication resource to scheduled-use information regarding a wireless communication resource, the scheduled-use information being held by the communication control apparatus 40 (Step S1602). Specifically, it is determined whether a position, a period of time, and a frequency band that are included in the use request respectively overlap a position, a period of time, and a frequency band that are adopted when the wireless communication resource is scheduled to be used by another communication system.

In particular, when there is a scheduled use for which a position overlaps the position included in the use request (S1603=YES), and when there is a scheduled use for which a period of time overlaps the period of time included in the use request (S1604=YES), and when there is a scheduled use for which a frequency band overlaps the frequency band included in the use request (S1605=YES), and when a communication system scheduled to perform the uses has a higher priority than a communication system having transmitted the use request (or a communication system that a communication apparatus having transmitted the use request belongs to) (S1606=YES), the communication control apparatus 40 determines that the wireless communication resource is not allowed to be used by the communication system or communication apparatus having transmitted the use request (S1607).

On the other hand, in a case other than the case described above, that is, when there is not a scheduled use for which a position overlaps the position included in the use request (S1603=NO), or when there is not a scheduled use for which a period of time overlaps the period of time included in the use request (S1604=NO), or when there is not a scheduled use for which a frequency band overlaps the frequency band included in the use request (S1605=NO), or when a communication system scheduled to perform the uses has a lower priority than a communication system having transmitted the use request (or a communication system that a communication apparatus having transmitted the use request belongs to) (S1606=NO), the communication control apparatus 40 grants, to the communication system or communication apparatus having transmitted the use request, permission to use a wireless communication resource (S1608), and updates the scheduled-use information held by the communication control apparatus 40 (S1609).

When the communication control apparatus 40 updates scheduled-use information, the communication control apparatus 40 adds, to the scheduled-use information, information such as a position, a period of time, and a frequency band that are included in a use request. Alternatively, when an existing scheduled use performed by a lower-priority communication system is changed or deleted due to a use request being made by a higher-priority communication system or communication apparatus, the scheduled-use information is changed or deleted on the basis of details of the change or deletion.

Finally, the communication control apparatus 40 reports an operational parameter to a communication system or communication apparatus having transmitted the use request, the operational parameter including whether a wireless communication resource can be used. Further, when an existing scheduled use has been changed or deleted, an operational parameter including details of the change or deletion is reported to a communication system of which the scheduled use has been changed or deleted.

Note that it may be determined that frequency bands overlap if the state corresponds to one of (1) to (5) in FIG. 2 described above. However, it may be determined that frequency bands do not overlap in the case of a frequency band that is actually not used by the primary system or in the case of a frequency band in which interference with the primary system from the secondary system can be considered ignorable, as in the case of (1), (3), (4), or (5) in FIG. 2. This is another determination method.

Likewise, it may be determined that periods of time overlap if the state corresponds to one of (1) to (6) in FIG. 3 described above. However, it may be determined that periods of time do not overlap in the case of a period of time that is actually not used by the primary system or in the case of a period of time for which interference with the primary system from the secondary system can be considered ignorable, as in the case of (1), (3), (4), (5), or (6) in FIG. 3. This is another determination method.

Further, the case in which it is determined, in response to a use request to use a wireless communication resource, that the wireless communication resource is not allowed to be used is discussed. When the wireless communication resource is not allowed to be used without changing an initial use request but is allowed to be used by changing, for example, a position, a period of time, and a frequency band, that is, in particular by a change that results in reducing use opportunities, compared to the initial case, an operational parameter including, for example, a position, a period of time, and a frequency band after the change may be reported together with a result of determining that the wireless communication resource is not allowed to be used.

Likewise, the case in which it is determined, in response to a use request to use a wireless communication resource, that the wireless communication resource is allowed to be used is discussed. When the wireless communication resource is not allowed to be used without changing an initial use request but is allowed to be used by changing, for example, a position, a period of time, and a frequency band, that is, in particular by a change that results in reducing use opportunities, compared to the initial case, an operational parameter including, for example, a position, a period of time, and a frequency band after the change may be reported together with a result of determining that the wireless communication resource is allowed to be used.

### (Operational Parameter (Maximum Allowed Transmission Power))

In the present disclosure, the communication control apparatus 40 reports an operational parameter to a communication system or a communication apparatus. Examples of information included in an operational parameter include a maximum allowed transmission power of a communication apparatus.

In a first method for determining a maximum allowed transmission power, a maximum allowed transmission power of a transmission-side communication apparatus (a first communication apparatus) is determined such that reception power received by a reception-side communication apparatus (a second communication apparatus) is greater than or equal to a requested level (requested reception power) when a radio signal is transmitted from the first communication apparatus to the second communication apparatus.

A condition indicated below is fulfilled when the requested reception power received by the second communication apparatus is P_{req,2}, the maximum allowed transmission power of the first communication apparatus is P_{alloc,1}, a maximum transmission power of the first communication apparatus in the specifications is P_{max,1}, and characteristics regarding radio wave propagation between the first communication apparatus and the second communication apparatus is N_{1→2}.

$$\begin{matrix}{P}_{alloc , 1} \geq {P}_{req , 2} + {N}_{1 \to 2} \\ {P}_{alloc , 1} \leq {P}_{max , 1}\end{matrix} \qquad [ Math . 14 ]$$

The communication control apparatus 40 determines the maximum allowed transmission power P_{alloc,1} of the first communication apparatus such that the condition described above is satisfied. In a calculation in this case may be performed by secure computation that uses encoded information regarding the communication apparatus.

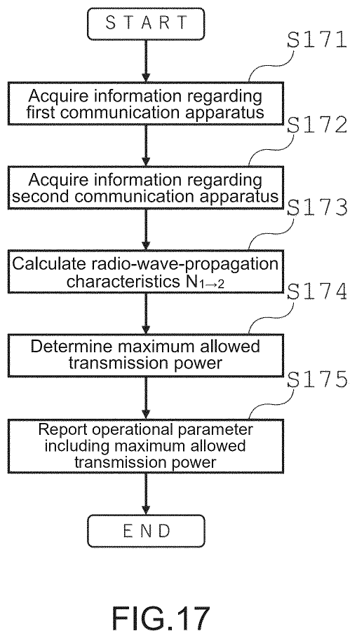

FIG. 17 is a flowchart used to describe an example of processing of determining a maximum allowed transmission power on the basis of the first determination method.

First, the communication control apparatus 40 acquires information regarding the specifications of and a settable operational parameter for the first communication apparatus and information regarding the specifications of and a settable operational parameter for the second communication apparatus (S171 and S172), and calculates characteristics N_{1→2} regarding radio wave propagation between the first communication apparatus and the second communication apparatus on the basis of the pieces of acquired information (S173). Next, the communication control apparatus 40 determines a maximum allowed transmission power P_{alloc,1} of the first communication apparatus that satisfies the condition described above (S174). Finally, the communication control apparatus 40 reports an operational parameter including information regarding the determined maximum allowed transmission power P_{alloc,1} (S175).

In a second method for determining a maximum allowed transmission power, maximum allowed transmission powers of the first communication apparatus to a K-th communication apparatus are determined such that a level of an aggregate interference power received by an M-th communication apparatus (M=K+1) is less than or equal to an allowed level (a maximum allowed interference power) when the first to K-th communication apparatuses each transmit a radio signal.

First, a condition indicated below is fulfilled when a maximum allowed interference power of the M-th communication apparatus is I_{accept,M}, the maximum allowed transmission power of the first communication apparatus is P_{alloc,1}, and characteristics regarding radio wave propagation between the first communication apparatus and the M-th communication apparatus is N_{1→M}.

$$\begin{matrix}{P}_{alloc , 1} \geq {I}_{accept , 2} + {N}_{1 \to 2} \\ {P}_{alloc , 1} \leq {P}_{max , 1}\end{matrix} \qquad [ Math . 15 ]$$

In order to generalize the example above, it is assumed that k=1 to K. A condition indicated below is fulfilled when a maximum allowed transmission power of a k-th communication apparatus is P_{alloc,k}, characteristics regarding radio wave propagation between the k-th communication apparatus and the M-th communication apparatus is N_{k→M}, and a maximum allowed interference power of the M-th communication apparatus from the k-th communication apparatus is I_{accept,k→M}.

$$\begin{matrix}{P}_{alloc , k} \leq {I}_{accpet , k \to M} + {N}_{k \to M} \\ {P}_{alloc , k} \leq {P}_{max , k} \\ {\sum }_{k} {I}_{accept , k \to M} \leq {I}_{accept , M}\end{matrix} \qquad [ Math . 16 ]$$

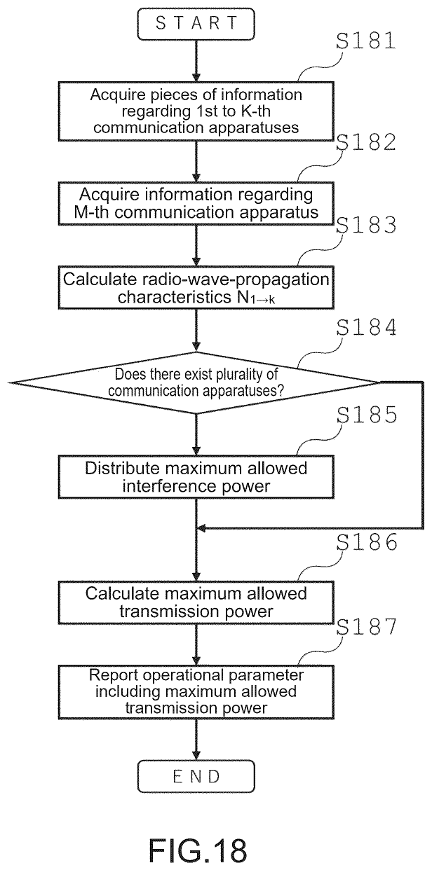

FIG. 18 is a flowchart used to describe an example of processing of determining a maximum allowed transmission power on the basis of the second determination method.

First, the communication control apparatus 40 acquires information regarding the specifications of and a settable operational parameter for each of the first to K-th communication apparatuses and information regarding the specifications of and a settable operational parameter for the M-th communication apparatus (S181 and S182), and calculates characteristics N_{k→M} regarding radio wave propagation between each of the first to K-th communication apparatuses and the M-th communication apparatus (k=1 to K) on the basis of the pieces of acquired information (S183).

Next, when K>2, that is, when there is a plurality of transmission-side communication apparatuses (S184=YES), the communication control apparatus 40 determines distribution of a maximum allowed interference power I_{accept,M} of the M-th communication apparatus to the first to K-th communication apparatuses, that is, I_{accept,k→M} (k=1 to K) (S185). Next, the communication control apparatus 40 determines a maximum allowed transmission power P_{alloc,k} of each of the first to K-th communication apparatuses that satisfies the condition described above (k=1 to K) (S186). Finally, the communication control apparatus 40 reports an operational parameter to each of the first to K-th communication apparatuses, the operational parameter including information regarding the determined maximum allowed transmission power P_{alloc,k} (S187).

### (Operational Parameter (Frequency Band and Radio Access Scheme))

In the present disclosure, the communication control apparatus 40 reports an operational parameter to a communication system or a communication apparatus. Examples of information included in an operational parameter include a frequency band and a radio access scheme that are used by the communication apparatus. Examples of the radio access scheme in the case of a cellular system include 4G LTE, 5G NR, and 6G, and examples of the radio access scheme in the case of a wireless LAN include IEEE802.11a/b/g/n/ac/ax/be, or Wi-Fi 4/5/6/7/8 (Wi-Fi standards of a higher level).

It is conceivable that a usable radio access scheme and a radio access scheme exhibiting suitable characteristics could differ depending on a position of a communication apparatus. Thus, there may be a need to select a radio access scheme to be used, while protecting position information regarding a position of the communication apparatus.

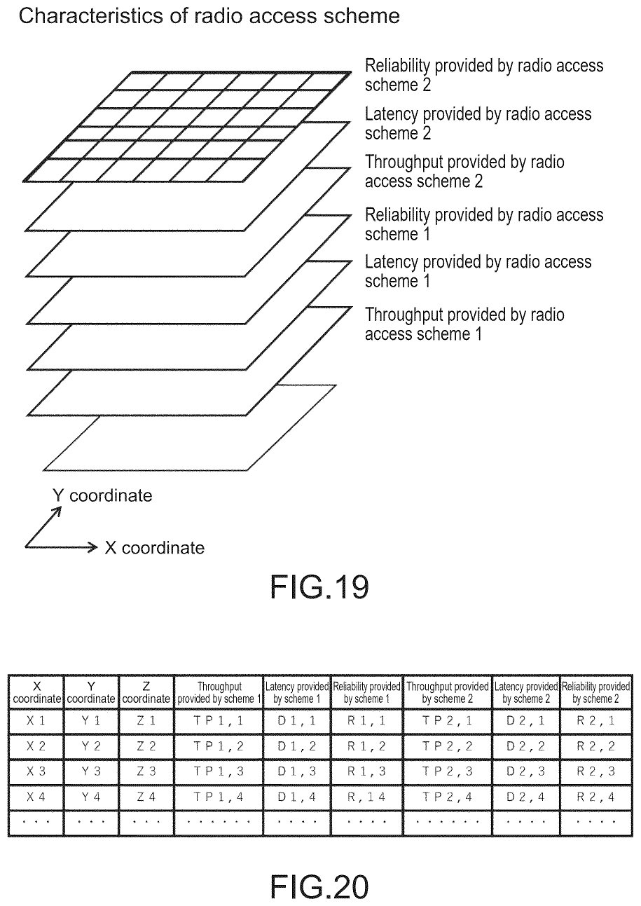

FIG. 19 illustrates an example of a data structure of characteristic information regarding characteristics of a radio access scheme. In order to make it possible to select a radio access scheme used by a communication apparatus, there is a need to consider a plurality of radio access schemes, as illustrated in the figure. Further, there is a need to consider a plurality of characteristic indicators for a single radio access scheme.

In the example illustrated in FIG. 19, “throughput”, “latency”, and “reliability” are included as characteristic indicators. These are characteristic indicators close to essential evaluation indicators for wireless communication. Further, environmental performance and an economic indicator, such as power consumption, CO2 consumption, and communication charges, may be included, although those are not illustrated in the figure.

The data structure of characteristic information regarding characteristics of a radio access scheme may be meshed with respect to the position, as illustrated in FIG. 20. Moreover, the characteristic information regarding characteristics of a radio access scheme illustrated in FIG. 20 may further generate for each frequency band. The characteristics of a radio access scheme are dependent on frequency. Thus, a radio access scheme can be selected more flexibly by applying a plurality of pieces of characteristic information according to such a feature. When there are pieces of characteristic information regarding characteristics of a radio access scheme for a plurality of frequency bands, position-and-coordinate information may be shared. The following is an advantage provided by sharing the position-and-coordinate information: when position information is compared to characteristic information regarding characteristics of a radio access scheme, the number of times of comparison can be reduced using the position-and-coordinate information as a key. When, for example, there are pieces of characteristic information regarding characteristics of a radio access scheme for M frequency bands, the number of times of comparison will be only 1/M in the case in which the position-and-coordinate information is shared, compared to when the position-and-coordinate information is not shared.

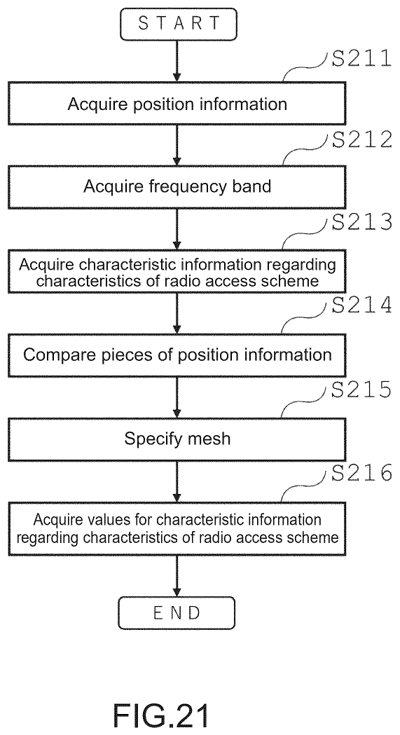

FIG. 21 is a flowchart used to describe a method for comparing position information to characteristic information regarding characteristics of a radio access scheme. First, position information that is to be checked against characteristic information regarding characteristics of a radio access scheme is acquired (Step S211). Next, when a specific frequency band is desired or designated (Step S212), characteristic information regarding characteristics of a radio access scheme that corresponds to the frequency band is acquired (Step S213). Next, position information/coordinate information that is included in the characteristic information regarding characteristics of a radio access scheme and obtained by meshing is compared with check-target position information (Step S214), and a mesh that is closest to the check-target position information is specified (Step S215). In the comparison and specifying, a method is adopted that includes comparing distances between position information obtained by meshing and check-target position information and specifying a closest mesh, as in the case of FIG. 14 described above. Finally, values of characteristic indicators of characteristic information regarding characteristics of a radio access scheme, that is, values in a specific line in FIG. 19, are acquired, the values of the characteristic indicators being set for and associated with the specified mesh (Step S216).

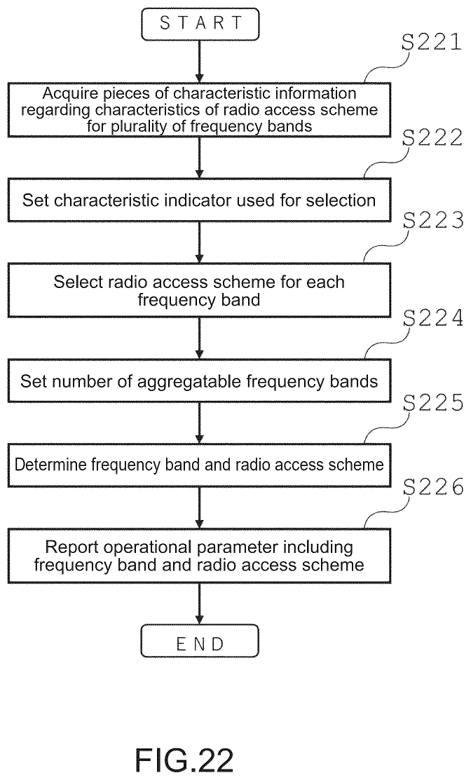

FIG. 22 is a flowchart used to describe an example of processing of determining a frequency band and a radio access scheme that are used by a communication apparatus.

First, the communication control apparatus 40 acquires pieces of characteristic information regarding characteristics of a radio access scheme for a plurality of frequency bands, each piece of characteristic information being acquired on the basis of the processing in FIG. 21 (Step S221). Next, the communication control apparatus 40 sets a characteristic indicator used to select a radio access scheme (Step S222). For example, “throughput” is set to be the characteristic indicator when communication is desired to be performed at a high speed, “latency” is set to be the characteristic indicator when low-latency communication is desired to be performed, and “reliability” is set to be the characteristic indicator when communication is desired to be performed with certainty. Not only a single characteristic indicator but also a composite characteristic indicator may be set.

Next, the communication control apparatus 40 selects a best radio access scheme for each frequency band in terms of the characteristic indicators set in Step S222 described above (Step S223). Further, the communication control apparatus 40 sets the number of aggregatable frequency bands (the number of frequency bands is one if unaggregatable (Step S224).

Subsequently, the communication control apparatus 40 selects a certain number of frequency bands used by a communication apparatus, the certain number being the number of aggregatable frequency bands and being set in Step S224 described above. The communication control apparatus 40 acquires the radio access schemes selected in Step S223 described above for the respective frequency bands, and determines the frequency bands and radio access schemes used by the communication apparatus (Step S225).

Finally, the communication control apparatus 40 reports, to the communication apparatus, an operational parameter including information regarding the frequency bands and radio access schemes determined in Step S225 described above (Step S226).

(Operational Parameter (Area in which Communication is Allowed to be Performed, Area in which Communication is not Allowed to be Performed, Boundary, and Minimum Separation Distance))

In the present disclosure, the communication control apparatus 40 reports an operational parameter to a communication system or a communication apparatus. Examples of information included in the operational parameter include an area in which communication is allowed to be performed by the communication apparatus system or the communication apparatus, an area in which the communication is not allowed to be performed, a boundary, and a minimum separation distance.

The area in which communication is allowed to be performed refers to an area in which a target communication system or a target communication apparatus is allowed to perform wireless communication. The area in which communication is not allowed to be performed refers to an area in which a target communication system or a target communication apparatus is not allowed to perform wireless communication or the wireless communication is banned (such as an exclusion zone). The boundary refers to a boundary of an area in which communication is allowed to be performed and an area in which communication is not allowed to be performed. The minimum separation distance refers to a minimum necessary separation distance between a target communication system and another communication system or between a target communication apparatus and another communication apparatus. The area in which communication is allowed to be performed and the area in which communication is not allowed to be performed may be defined planarly (two-dimensionally) or spatially (three-dimensionally), or may be defined by a planar or spatial boundary line or boundary plane (contour).

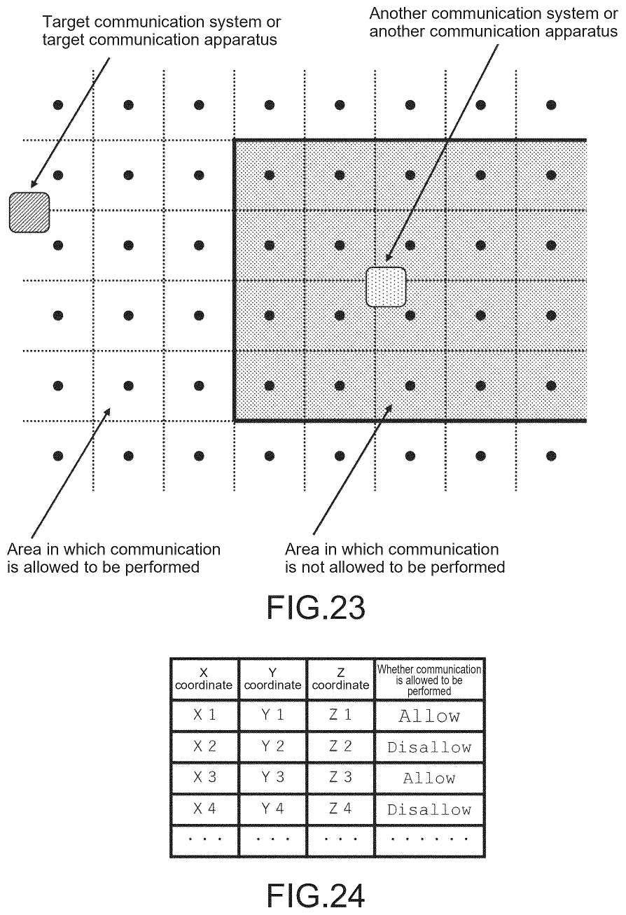

FIG. 23 illustrates an example of an area in which communication is allowed to be performed, an area in which communication is not allowed to be performed, and a boundary of the areas. In this example, a target communication system or a target communication apparatus belongs to the secondary system, and another communication system or another communication apparatus belongs to the primary system. In this case, a region that is relatively close to the other communication system or the other communication apparatus can be determined to be an area in which the communication system or the target communication apparatus is not allowed to perform wireless communication. On the other hand, a region that is relatively distant from the other communication system or the other communication apparatus can be determined to be an area in which the target communication system or the target communication apparatus is allowed to perform wireless communication.

Note that, in the example illustrated in FIG. 23, each of the area in which communication is allowed to be performed and the area in which communication is not allowed to be performed is in a grid, and the boundary of the areas is defined using straight lines. However, for example, a grid cell of the area in which communication is allowed to be performed and a grid cell of the area in which communication is not allowed to be performed may have different sizes. Alternatively, the boundary of the area in which communication is allowed to be performed and the area in which communication is not allowed to be performed may be defined using curved lines.

When a virtual position of the target communication apparatus is assumed to be Loc_{SS}, a set of the virtual positions LOC_{SS} that satisfies a condition indicated below can be determined to be the area in which communication is allowed to be performed, where transmission power of the target communication apparatus is P_{T,SS}, a position of the other communication apparatus is LOC_{PS}, interference power received by the other communication apparatus is I_{SS→PS}, and an allowed interference power of the other communication apparatus is I_{accept,PS}.

$${Loc}_{allow} ∋ {arg}_{{Loc}_{SS}} ( {I}_{SS \to PS} \leq {I}_{accept , PS} \vert {Loc}_{SS} , {Loc}_{PS} , {P}_{T , SS} ) \qquad [ Math . 17 ]$$

The formula above indicates that an area LOC_{allow} in which communication is allowed to be performed is a set of the virtual positions Loc_{SS} such that the interference power I_{SS→PS} received by the other communication apparatus is less than or equal to the allowed interference power I_{accept,PS} when it is assumed that the target communication apparatus emits radio waves with the transmission power P_{T,SS} at the virtual position LOC_{SS}.

When a virtual position of the target communication apparatus is assumed to be Loc_{SS}, a set of the virtual positions Loc_{SS} that satisfies a condition indicated below can be determined to be the area in which communication is not allowed to be performed, where transmission power of the target communication apparatus is P_{T,SS}, a position of the other communication apparatus is Loc_{PS}, interference power received by the other communication apparatus is I_{SS→PS}, and an allowed interference power of the other communication apparatus is I_{accept,PS}.

$${Loc}_{disallow} ∋ {arg}_{{Loc}_{SS}} ( {I}_{SS \to PS} > {I}_{accept , PS} \vert {Loc}_{SS} , {Loc}_{PS} , {P}_{T , SS} ) \qquad [ Math . 18 ]$$

The formula above indicates that an area LOC_{disallow} in which communication is not allowed to be performed is a set of the virtual positions Loc_{SS} such that the interference power I_{SS→PS} received by the other communication apparatus is greater than the allowed interference power I_{accept,PS} when it is assumed that the target communication apparatus emits radio waves with the transmission power P_{T,SS} at the virtual position Loc_{SS}.

With respect to a combination of a certain communication apparatus and another communication apparatus, the area Loc_{allow} in which communication is allowed to be performed, and an area LOC_{disallow} in which communication is not allowed to be performed are regions that do not overlap each other, and it is considered that these areas have no shared elements in the set-related term. Thus, when a set of pieces of position information regarding the entirety of a region for which the present disclosure is intended is represented by Locₐₗₗ, the area LOC_{disallow} in which communication is not allowed to be performed may be determined after the area Loc_{allow} in which communication is allowed to be performed is determined, where the area LOC_{disallow} is obtained by distracting Loc_{allow} from the entire set Locₐₗₗ.

$${Loc}_{disallow} = {Loc}_{all} - {Loc}_{allow} \qquad [ Math . 19 ]$$

Alternatively, conversely, the area Loc_{allow} in which communication is allowed to be performed may be determined after the area LOC_{disallow} in which communication is not allowed to be performed is determined, where the area Loc_{allow} is obtained by distracting LOC_{disallow} from the entire set Locₐₗₗ.

$${Loc}_{allow} = {Loc}_{all} {Loc}_{disallow} \qquad [ Math . 20 ]$$

When a virtual position of the target communication apparatus is assumed to be Loc_{SS}, a set of the virtual positions Loc_{SS} that satisfies a condition indicated below can be determined to be the boundary of the area in which communication is allowed to be performed and the area in which communication is not allowed to be performed, where transmission power of the target communication apparatus is P_{T,SS}, a position of the other communication apparatus is Loc_{PS}, interference power received by the other communication apparatus is I_{SS→PS}, and an allowed interference power of the other communication apparatus is I_{accept,PS}.

$${Loc}_{contour} ∋ {arg}_{{Loc}_{SS}} ( {I}_{accept , PS} - {ε}_{Low} \leq {I}_{SS \to PS} \leq {I}_{accept , PS} + {ε}_{High} \vert {Loc}_{SS} , {Loc}_{PS} , {P}_{T , SS} ) \qquad [ Math . 21 ]$$

The formula above indicates that a boundary Loc_{contour} is a set of the virtual positions Loc_{SS} such that the interference power I_{SS→PS} received by the other communication apparatus is in a specified range (I_{accept,PS}−ε_{Low}, I_{accept,PS}+ε_{High}) when it is assumed that the target communication apparatus emits radio waves with the transmission power P_{T,SS} at the virtual position LOC_{SS}.

Note that, in the formula above, ε represents a coefficient used to determine an interference power range used to obtain a boundary. ε is desired to be a non-negative number. When ε is zero, Loc_{contour} represents a line having no width. When ε is not zero, Loc_{contour} has the area or the volume.

When a virtual position of the target communication apparatus is assumed to be Loc_{SS}, a distance that satisfies a condition indicated below can be determined to be the minimum separation distance between the target communication apparatus and the other communication apparatus, where transmission power of the target communication apparatus is P_{T,SS}, a position of the other communication apparatus is Loc_{PS}, interference power received by the other communication apparatus is I_{SS→PS}, and an allowed interference power of the other communication apparatus is I_{accept,PS}.

$${D}_{separate} = {min}_{{Loc}_{SS , {Loc}_{PS} , {P}_{T , SS}}} ( {D}_{SS \to PS} \vert {I}_{SS \to PS} \leq {I}_{accept , PS} ) \qquad [ Math . 22 ]$$

The formula above indicates that a minimum separation distance Dₛₑₚₐᵣₐₜₑ is a minimum value of a distance between Loc_{SS} and Loc_{PS} under the constraint of a set of virtual positions Loc_{SS} such that the interference power I_{SS→PS} received by the other communication apparatus is less than or equal to the allowed interference power I_{accept,PS} when it is assumed that the target communication apparatus emits radio waves with the transmission power P_{T,SS} at the virtual position Loc_{SS}.

FIG. 24 illustrates an example in which an area in which communication is allowed to be performed and an area in which communication is not allowed to be performed are held as geographic information. Here, secret sharing may be performed and information regarding whether communication is allowed to be performed (allow or disallow) may be held in the form of secret shares. The secret sharing also makes it possible to protect information regarding whether a target communication apparatus is actually operable.

### (Cancellation of Registration of Communication Apparatus or Radio Wave Propagation Controlling Apparatus)

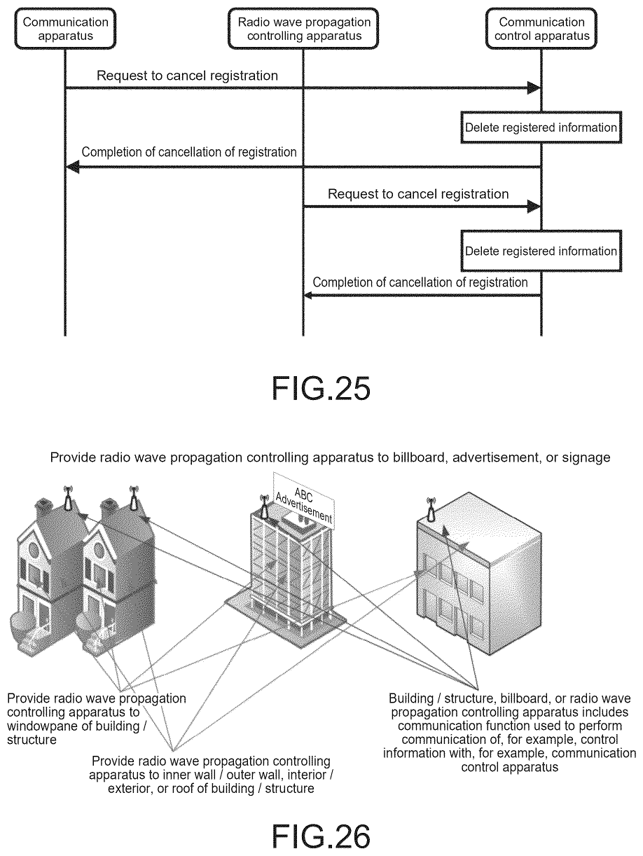

FIG. 25 is a sequence diagram illustrating an example of processing of canceling registration of a communication apparatus or a radio wave propagation controlling apparatus. When the communication control apparatus 40 receives a request to cancel registration of a certain communication apparatus or a certain radio wave propagation controlling apparatus, the communication control apparatus 40 deletes registered information regarding the communication apparatus or the radio wave propagation controlling apparatus. When the deletion of the registered information is completed, the communication control apparatus 40 reports the completion of cancellation of registration to the communication apparatus or the radio wave propagation controlling apparatus. The deletion of information regarding a communication apparatus or a radio wave propagation controlling apparatus communication apparatus upon cancellation of registration of the communication apparatus or the radio wave propagation controlling apparatus makes it possible to protect information regarding the communication apparatus or the radio wave propagation controlling apparatus with certainty. The request to cancel registration of a communication apparatus or a radio wave propagation controlling apparatus may be transmitted by the communication apparatus or the radio wave propagation controlling apparatus, or may be transmitted by another apparatus. Alternatively, a human may manually transmit the request to cancel registration.

Further, the communication control apparatus 40 may cancel registration of a certain communication apparatus except when a request to cancel registration is received, that is, for example, when it has been found out that the communication apparatus uses setting that violates an operational parameter designated by the communication control apparatus 40, or when it has been found out that the communication apparatus has given interference power that is not allowed by another communication system.

In the cases described above, the communication control apparatus 40 may report a reason for cancellation of registration to the communication apparatus at the time of reporting completion of the cancellation of registration. Accordingly, the communication apparatus of which registration has been canceled can determine whether the registration has been canceled according to the intention of the communication apparatus itself. This enables the communication apparatus to take proper measures. Examples of the measures could include making a request for an operational parameter that makes it possible to reduce interference with another communication system.

### (Embodiments of Radio Wave Propagation Controlling Apparatus)

It is conceivable that the radio wave propagation controlling apparatus could be provided in the form of a separate item. For example, the radio wave propagation controlling apparatus may be provided in the form of a reflective plate, a passive reflector, or an active reflector. Further, in addition to being provided in the form of a separate item, the radio wave propagation controlling apparatus may be provided by being included in a product including another function.

The function of the radio wave propagation controlling apparatus may be provided to, for example, a wall material (an outer wall or an inner wall), a door/a gate, a window, or a roof of a house or a building, as illustrated in, for example, FIG. 26. This makes it possible to prevent radio waves of wireless communication performed indoors from going outside unnecessarily, or, conversely, this makes it possible to prevent radio waves of wireless communication performed outdoors from going indoors unnecessarily.

In the case of large buildings, the function of the radio wave propagation controlling apparatus may be provided to, for example, a wall material or a ceiling surface of a dome studium. Further, the function of the radio wave propagation controlling apparatus may be provided to, for example, an advertisement, a billboard, or a signage that is installed indoors or outdoors. The billboards and others described above are often seen in everyday spaces. Thus, the provision of the function of the radio wave propagation controlling apparatus to the billboards and others makes it easier to improve introduction costs, compared to when the radio wave propagation controlling apparatus in the form of a separate item is introduced.

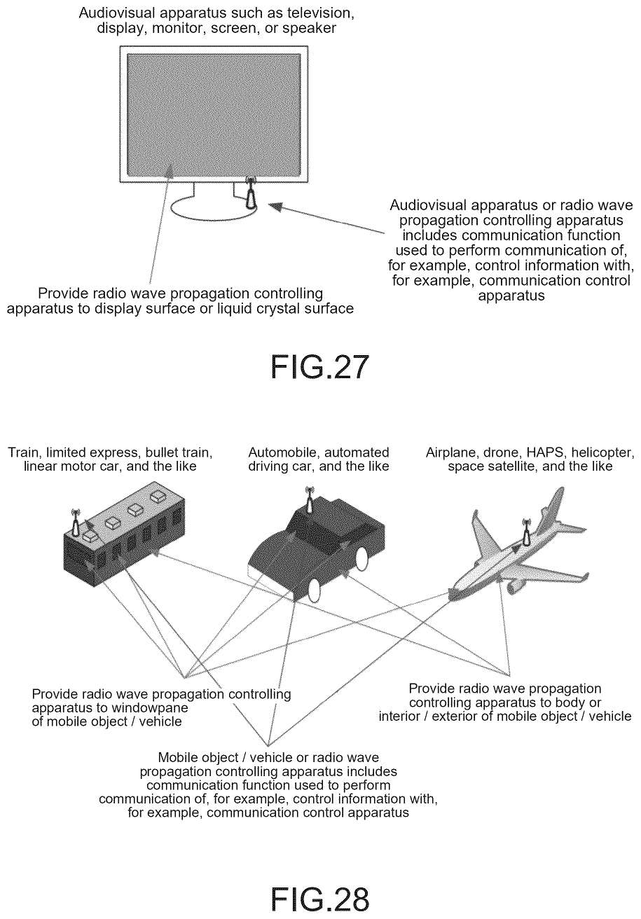

Further, the function of the radio wave propagation controlling apparatus may be provided to, for example, a product, such as a television screen, a personal computer screen, or a mirror, that has a relatively large area in a house or a living space, as illustrated in, for example, FIG. 27.

With respect to indoor or outdoor radio waves, the function of the radio wave propagation controlling apparatus may be provided to a body or glass of a mobile object such as an automobile, a train, or an airplane, as illustrated in, for example, FIG. 28. Effects similar to those provided in the case of a house or a building are expected to be provided. When the function of the radio wave propagation controlling apparatus is provided to a mobile object, information regarding radio wave propagation control, such as position information regarding a position of a mobile object provided with such a function and a pose of the mobile object, is favorably reported to the communication control apparatus 40 to be updated. The communication control apparatus 40 receiving the report and update favorably performs interference calculation including calculation of characteristics of the radio wave propagation controlling apparatus, on the basis of updated information.

### Conclusion

The technology according to the present disclosure is not limited to specific standards, and illustrated settings may be modified as appropriate. Note that the examples described above are examples used to embody the present disclosure, and the present disclosure may be embodied in a variety of other embodiments. For example, various modifications, replacements, omissions, or combinations may be applied without departing from the scope of the present disclosure. Embodiments obtained by applying, for example, such modifications, replacements, omissions, or combinations are also included in the scope of the present disclosure, as well as the scope of embodiments of the present disclosure and their equivalents.

Further, the processing procedures described in the present disclosure may be considered a method including a series of the procedures. Alternatively, the processing procedures described in the present disclosure may be considered a program used to cause a computer to perform the series of the procedures, or a recording medium that has stored therein the program. Further, the processing described above is performed by a processor such as a CPU of a computer. Further, the type of the recording medium is not particularly limited since the examples of the present disclosure are not affected by the type of the recording medium.

Note that the illustrated structural elements of the present disclosure may be provided by software or may be implemented by hardware. For example, each structural element may be a software module provided by software such as a microprogram, and may be provided by a processor executing the software module. Alternatively, each structural element may be implemented by a circuit block on a semiconductor chip (a die), that is, for example, an integrated circuit such as an application specific integrated circuit (ASIC) or a field programmable gate array (FPGA). Further, the number of structural elements does not necessarily have to be equal to the number of pieces of hardware by which the structural elements are implemented. For example, a plurality of structural elements may be implemented by a single processor or circuit. Conversely, a single structural element may be implemented by a plurality of processors or circuits.

Note that the type of the processor described in the present disclosure is not limited. For example, the processor may be a CPU, a micro processing unit (MPU), or a graphics processing unit (GPU).

Note that the present disclosure may take the following configurations.
[1] A communication control apparatus, including:
   a first receiver that receives position information regarding a position of a first communication apparatus and position information regarding a position of a second communication apparatus;
   a second receiver that receives position information regarding a position of a radio wave propagation controlling apparatus and characteristic information regarding characteristics of the radio wave propagation controlling apparatus;
   a first calculator that calculates a distance and a direction between the first communication apparatus and the second communication apparatus on the basis of the position information regarding the position of the first communication apparatus and the position information regarding the position of the second communication apparatus;
   a second calculator that calculates characteristics regarding radio wave propagation between the first communication apparatus and the second communication apparatus on the basis of the distance between the first communication apparatus and the second communication apparatus, the direction between the first communication apparatus and the second communication apparatus, the position information regarding the position of the radio wave propagation controlling apparatus, and the characteristic information regarding the characteristics of the radio wave propagation controlling apparatus; and
   a first determination section that determines an operational parameter for the radio wave propagation controlling apparatus on the basis of the characteristics regarding the radio wave propagation between the first communication apparatus and the second communication apparatus.
[2] The communication control apparatus according to [1], further including
   a detector that detects a radio wave propagation controlling apparatus available to prevent radio waves of the first communication apparatus from interfering with radio waves of the second communication apparatus or to reduce the interference, the detection being performed on the basis of the position information regarding the position of the first communication apparatus, the position information regarding the position of the second communication apparatus, the position information regarding the position of the radio wave propagation controlling apparatus, and the characteristic information regarding the characteristics of the radio wave propagation controlling apparatus, in which
   when the second calculator calculates the characteristics regarding the radio wave propagation between the first communication apparatus and the second communication apparatus, the second calculator only considers position information regarding a position of the available radio wave propagation controlling apparatus and characteristic information regarding characteristics of the available radio wave propagation controlling apparatus.
[3] The communication control apparatus according to claim [2], in which
   the detector sets, as a detection range, a line that connects the first communication apparatus and the second communication apparatus, and detects, as the available radio wave propagation controlling apparatus, the radio wave propagation controlling apparatus situated in the line.
[4] The communication control apparatus according to [2], in which
   the detector sets, as a detection range, a region in which the first communication apparatus and the second communication apparatus are situated, and detects, as the available radio wave propagation controlling apparatus, the radio wave propagation controlling apparatus situated in the region.
[5] The communication control apparatus according to any one of [1] to [4], in which
   when the second calculator calculates the characteristics regarding the radio wave propagation between the first communication apparatus and the second communication apparatus, the second calculator considers geographic information regarding geography exhibited between the first communication apparatus and the second communication apparatus.
[6] The communication control apparatus according to [5], in which
   the geographic information includes at least one of a distance-dependent parameter, a shadowing parameter, or a fading parameter that has an impact on the characteristics regarding the radio wave propagation between the first communication apparatus and the second communication apparatus.
[7] The communication control apparatus according to any one of [1] to [6], further including
   a third calculator that calculates power of an interference signal received by the second communication apparatus when the first communication apparatus emits radio waves, the calculation being performed on the basis of the characteristics regarding the radio wave propagation between the first communication apparatus and the second communication apparatus.
[8] The communication control apparatus according to [7], further including
   a second determination section that determines an operational parameter for the first communication apparatus on the basis of the interference signal power.
[9] A radio wave propagation controlling apparatus that is capable of controlling radio-wave-propagation characteristics of the radio wave propagation controlling apparatus according to an operational parameter received from a communication control apparatus.
[10] The radio wave propagation controlling apparatus according to [9], in which
   the radio-wave-propagation characteristics include at least one of angles of reflection, scatter, diffraction, and transmission of radio waves.
[11] The radio wave propagation controlling apparatus according to [9], in which
   the operational parameter is determined so as to prevent radio waves of a first communication apparatus from interfering with radio waves of a second communication apparatus, or so as to reduce the interference.

### REFERENCE SIGNS LIST

10 primary system
12a access point (communication apparatus)
12b terminal apparatus (communication apparatus)
20 secondary system
21 core network
22a base station (communication apparatus)
22b terminal apparatus (communication apparatus)
22c terminal apparatus (communication apparatus)
30a radio wave propagation controlling apparatus
30b radio wave propagation controlling apparatus
30c radio wave propagation controlling apparatus
40 communication control apparatus
401 first receiver
402 first transmitter
403 second receiver
404 second transmitter
405 first calculator
406 detector
407 second calculator
408 third calculator
409 first determination section
410 second determination section
411 controller
50 Internet link
60 information recording apparatus

1. A communication control apparatus, comprising:
a first receiver that receives position information regarding a position of a first communication apparatus and position information regarding a position of a second communication apparatus;
a second receiver that receives position information regarding a position of a radio wave propagation controlling apparatus and characteristic information regarding characteristics of the radio wave propagation controlling apparatus;
a first calculator that calculates a distance and a direction between the first communication apparatus and the second communication apparatus on a basis of the position information regarding the position of the first communication apparatus and the position information regarding the position of the second communication apparatus;
a second calculator that calculates characteristics regarding radio wave propagation between the first communication apparatus and the second communication apparatus on a basis of the distance between the first communication apparatus and the second communication apparatus, the direction between the first communication apparatus and the second communication apparatus, the position information regarding the position of the radio wave propagation controlling apparatus, and the characteristic information regarding the characteristics of the radio wave propagation controlling apparatus; and
a first determination section that determines an operational parameter for the radio wave propagation controlling apparatus on a basis of the characteristics regarding the radio wave propagation between the first communication apparatus and the second communication apparatus.

2. The communication control apparatus according to claim 1, further comprising
a detector that detects a radio wave propagation controlling apparatus available to prevent radio waves of the first communication apparatus from interfering with radio waves of the second communication apparatus or to reduce the interference, the detection being performed on a basis of the position information regarding the position of the first communication apparatus, the position information regarding the position of the second communication apparatus, the position information regarding the position of the radio wave propagation controlling apparatus, and the characteristic information regarding the characteristics of the radio wave propagation controlling apparatus, wherein
when the second calculator calculates the characteristics regarding the radio wave propagation between the first communication apparatus and the second communication apparatus, the second calculator only considers position information regarding a position of the available radio wave propagation controlling apparatus and characteristic information regarding characteristics of the available radio wave propagation controlling apparatus.

3. The communication control apparatus according to claim 2, wherein
the detector sets, as a detection range, a line that connects the first communication apparatus and the second communication apparatus, and detects, as the available radio wave propagation controlling apparatus, the radio wave propagation controlling apparatus situated in the line.

4. The communication control apparatus according to claim 2, wherein
the detector sets, as a detection range, a region in which the first communication apparatus and the second communication apparatus are situated, and detects, as the available radio wave propagation controlling apparatus, the radio wave propagation controlling apparatus situated in the region.

5. The communication control apparatus according to claim 1, wherein
when the second calculator calculates the characteristics regarding the radio wave propagation between the first communication apparatus and the second communication apparatus, the second calculator considers geographic information regarding geography exhibited between the first communication apparatus and the second communication apparatus.

6. The communication control apparatus according to claim 5, wherein
the geographic information includes at least one of a distance-dependent parameter, a shadowing parameter, or a fading parameter that has an impact on the characteristics regarding the radio wave propagation between the first communication apparatus and the second communication apparatus.

7. The communication control apparatus according to claim 1, further comprising
a third calculator that calculates power of an interference signal received by the second communication apparatus when the first communication apparatus emits radio waves, the calculation being performed on a basis of the characteristics regarding the radio wave propagation between the first communication apparatus and the second communication apparatus.

8. The communication control apparatus according to claim 7, further comprising
a second determination section that determines an operational parameter for the first communication apparatus on a basis of the interference signal power.

9. A radio wave propagation controlling apparatus that is capable of controlling radio-wave-propagation characteristics of the radio wave propagation controlling apparatus according to an operational parameter received from a communication control apparatus.

10. The radio wave propagation controlling apparatus according to claim 9, wherein
the radio-wave-propagation characteristics include at least one of angles of reflection, scatter, diffraction, and transmission of radio waves.

11. The radio wave propagation controlling apparatus according to claim 9, wherein
the operational parameter is determined so as to prevent radio waves of a first communication apparatus from interfering with radio waves of a second communication apparatus, or so as to reduce the interference.
